(19) United States
(12) Patent Application Publication
(10) Pub. No.: US 2008/0264254 A1
(43) Pub. Date: Oct. 30, 2008

(54) Novel sorbents and purification and bulk separation of gas streams

(75) Inventors: Chunshan Song, State College, PA (US); Xiaoliang Ma, Port Matilda, PA (US); Xiaoxing Wang, State College, PA (US)

Correspondence Address: John A. Parrish;Law Offices of John A. Parrish, Suite 300, Two Bala Plaza, Bala Cynwyd, PA, 19004, US

(73) Assignee: The Penn State Research Foundation, University Park, PA (US)

(21) Appl. No.: 12/081,036

(22) Filed: Apr. 9, 2008

Related U.S. Application Data
(60) Provisional application No. 60/922,909, filed on Apr. 11, 2007.
(60) Provisional application No. 60/935,576, filed on Aug. 20, 2007.
(60) Provisional application No. 60/966,262, filed on Aug. 27, 2007.

(51) Int. Cl. B01D 53/02; B01J 20/26

(52) U.S. Cl. 95/116; 502/402; 95/141

(57) ABSTRACT

Porous-material-supported polymer sorbents and process for removal of undesirable gases such as H₂S, COS, CO₂, N₂O, NO, NO₂, SO₂, SO₃, HCl, HF, HCN, NH₃, H₂O, C₂H₅OH, CH₃OH, HCHO, CHCl₃, CH₂Cl₂, CH₃Cl, CS₂, C₄H₄S, CH₃SH, and CH₃—S—CH₃ from various gas streams such as natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air are disclosed. The sorbents have numerous advantages such as high breakthrough capacity, high sorption/desorption rates, little or no corrosive effect and are easily regenerated. The sorbents may be prepared by loading H₂S—, COS—, CO₂—, N₂O, NO—, NO₂—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH₃-philic polymer(s) or mixtures thereof, as well as any one or more of H₂S—, COS—, CO₂—, N₂O, NO—, NO₂—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH₃-philic compound(s) or mixtures thereof on to porous materials such as mesoporous, microporous or macroporous materials. The sorbents may be employed in processes such as one-stage and multi-stage processes to remove and recover H₂S, COS, CO₂, N₂O, NO, NO₂, SO₂, SO₃, HCl, HF, HCN, NH₃, H₂O, C₂H₅OH, CH₃OH, HCHO, CHCl₃, CH₂Cl₂, CH₃Cl, CS₂, C₄H₄S, CH₃SH and CH₃—S—CH₃ from gas streams by use of, such as, fixed-bed sorbers, fluidized-bed sorbers, moving-bed sorbers, and rotating-bed sorbers.

This application claims priority to U.S. Provisional Patent Application 60/920,909 filed Apr. 11, 2007, U.S. Provisional Patent Application 60/935,576 filed Aug. 20, 2007 and U.S. Provisional Patent Application 60/966,262 filed Aug. 27, 2007.

### FIELD OF THE INVENTION

The invention generally relates to sorbents and sorption processes for sorption and separation of impurities such as CO₂, H₂S, NH₃, H₂O, CH₃—S—CH₃, COS, NO₂, NO, N₂O, SO₂, SO₃, HCl, HF, HCN, C₂H₅OH, CH₃OH, HCHO, CHCl₃, CH₂Cl₂, CH₃Cl, CS₂, C₄H₄S, and CH₃SH from gas streams such as natural gas, coal/biomass gasification gas, biogas, landfill gas, coal mine gas, reformate gas, ammonia syngas, H₂ and oxo-syngas, Fe ore reduction gas, refinery process gases, flue gas, indoor air, fuel cell anode fuel gas and cathode air.

### BACKGROUND OF THE INVENTION

Gas streams such as natural gas, coal/biomass gasification gas, biogas, landfill gas, coal mine gas, reformate gas, ammonia syngas, H₂ and oxo-syngas, Fe ore reduction gas, refinery process gases, indoor air, fuel cell anode fuel gas and cathode air typically have undesirable acidic gases such as CO₂, H₂S and/or COS. H₂S is undesirable because it has an offensive odor and is corrosive to equipment and pipelines. Moreover, H₂S is poisonous to downstream catalysts, electrode catalysts in proton-exchange membrane fuel cells and solid oxide fuel cells. COS can produce H₂S when H₂O is present in gas streams. COS also is poisonous to downstream catalysts, electrode catalysts in proton-exchange membrane fuel cells and solid oxide fuel cells. CO₂ is undesirable because it reduces the thermal value of a fuel gas. CO₂, moreover, is a green house gas, and is required to be separated from gas streams and sequestrated. CO₂ in cathode air also causes the degradation of the alkali fuel cell. Purification and bulk separation of gas streams and recovery of H₂S, COS, CO₂ and other contaminates from gas streams therefore are important for environmental protection and reduction of green house gas release and for downstream applications of the gas streams.

A major challenge in production and utilization of fuel gases is to clean up the gas and to improve their utility and thermal values by removal of impurities such as H₂S, COS and CO₂. Methods which employ chemical and physical solvents to remove the impurities such as H₂S, COS and CO₂ are known in the art. These methods, however, suffer significant disadvantages. For instance, solvents such as liquid amines are highly corrosive, are lost due to evaporation during regeneration, degradation due to oxidation and formation of the heat stable amine salts and require extensive waste treatment. Methods which employ chemical and physical solvents also do not achieve high rates of sorption and desorption, and are unable to remove sulfur from gas streams to a level sufficient to enable the treated fuel gases to be employed in fuel cells.

For indoor air quality, the concentration of indoor CO₂ is used as a main criterion and its limit value of 1000 ppm is used to determine indoor air quality. Indoor air often contains trace amounts of harmful gases such as NO₂, NO, N₂O, SO₂, SO₃, H₂S, HCl, HF, HCN, NH₃, H₂O, C₂H₅OH, CH₃OH, HCHO, CHCl₃, CH₂Cl₂, CH₃Cl, CS₂, C₄H₄S, CH₃SH and CH₃—S—CH₃ depending on the circumstances. In the United States, a large number of people spend more than 90% of their life indoors. Evidence shows that constant exposure to indoor air that has a high CO₂ concentration tends to cause health issues such as insufficient oxygen supply to the brain. In many homes, offices, malls, buildings and other closed rooms where an air conditioning system is used, the concentrations of CO₂ and pollutant gases are often much higher compared to outdoor air due to people's activities. Removal of the excessive CO₂ and other harmful gases from indoor air is important for improving the living environment.

Metals and metal oxides such as Ni, Fe₂O₃ and ZnO also have been used as sorbents to remove H₂S from gas streams. Use of metals and metal oxides, however, requires higher operating temperatures. In addition, the spent sorbents cannot be easily regenerated and tend to degrade significantly in cycles. Metals and metal oxides such as ZnO also are not efficient sorbents for COS.

Membranes also have been used to separate H₂S and CO₂ from gas streams. Membranes, however, are unable to remove H₂S to a level sufficient to enable the treated fuel gas to be employed in fuel cells. Membranes also have low selectivity and generate high losses of valuable gases. In addition, some membranes for H₂ and CO₂ separation are easily poisoned by H₂S and COS.

A need therefore exists for new materials and methods to remove and recover undesirable gaseous components such as H₂S, COS, CO₂, NO₂, NO, N₂O, SO₂, SO₃, HCl, HF, HCN, NH CO₂, H₂O, C₂H₅OH, CH₃OH, HCHO, CHCl₃, CH₂Cl₂, CH₃Cl, CS₂, C₄H₄S, CH₃SH and CH₃—S—CH₃ from various gas streams such as natural gas, coal/biomass gasification gas, biogas, landfill gas, coal mine gas, reformate gas, ammonia syngas, H₂ and oxo-syngas, Fe ore reduction gas, refinery process gases, flue gas, indoor air, fuel cell anode fuel gas and cathode air.

### BRIEF DESCRIPTION OF THE DRAWINGS

FIG. 1 is a schematic diagram of an apparatus for use in two stage separation processes to separate and recover gases such as H₂S and CO₂ from gas streams.

FIG. 2 is a schematic diagram of an apparatus for two stage separation processes to separate gases such as H₂S and CO₂ from gas streams.

### SUMMARY OF THE INVENTION

Porous-material-supported polymer sorbents and separation processes for removal of acid gases such as H₂S, COS and/or CO₂ from gas streams such as natural gas, coal/biomass gasification gas, biogas, landfill gas, coal mine gas, reformate gas, ammonia syngas, H₂ and oxo-syngas, Fe ore reduction gas, refinery process gases, flue gas, indoor air, fuel cell anode fuel gas and cathode air are disclosed. The sorbents have numerous advantages such as high breakthrough/saturation capacity, high sorption/desorption rates, little or no corrosive effect and are easily regenerated. The sorbents may be used in both one-stage and multi-stage separation processes. Mixtures of sorbents may be used in both one-stage and multi-stage separation processes. The sorbents used in each stage of a multi-stage process such as a two-stage separation process may be the same or different. Mixtures of sorbents may be used in each stage of a multi-stage process such as a two-stage separation process.

In one aspect, a sorbent for sorbing one or more impurities from a gas stream is disclosed. The sorbent includes a first component for sorbing one or more impurities from the gas stream, and a second component comprising a porous support material for supporting the first component. The first component may be any of polyethyleneglycolamine (PEGA), polyethyleneimine (PEI), polyethanolamine (PEA), polyisopropanolamine (PIPA), polyalkylene glycol dimethyl ether (PAGDE), polyethylene glycol (PEG), n-methylpyrrolidinone (NMP), n-formylmorpholine (NFM), N-acetylmorpholine (NAM), propylene carbonate, sulfolane, or mixtures thereof, and the porous support material is selected from the group consisting of alumino-silicates, activated carbon, carbon sieve, silica gel, fumed silica, silica or mixtures thereof.

In another aspect, a single stage process for separation of an impurity from a feed gas stream is disclosed. The process entails contacting the feed gas stream having an impurity over a bed of a sorbent at a flow rate GHSV of about 200 h⁻¹ to about 200,000 h⁻¹ at a temperature of about −10° C. to about 80° C. to remove the impurity from the gas stream to produce an effluent that has a lower amount of the impurity than the feed gas stream. The impurity may be one or more of CO₂, H₂S, COS, NO₂, NO, N₂O, SO₂, SO₃, HCl, HF, HCN, NH₃, H₂O, C₂H₅OH, CH₃OH, HCHO, CHCl₃, CH₂Cl₂, CH₃Cl—, CS₂, C₄H₄S, CH₃SH, CH₃—S—CH₃ and mixtures thereof. The gas stream may be any one or more of natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air. The sorbent includes a first component for sorbing one or more impurities from the gas stream, and a second component comprising a porous support material for supporting the first component. The first component may be any of polyethyleneglycolamine (PEGA), polyethyleneimine (PEI), polyethanolamine (PEA), polyisopropanolamine (PIPA), polyalkylene glycol dimethyl ether (PAGDE), polyethylene glycol (PEG), n-methylpyrrolidinone (NMP), n-formylmorpholine (NFM), N-acetylmorpholine (NAM), propylene carbonate, sulfolane, or mixtures thereof, and the porous support material is selected from the group consisting of alumino-silicates, activated carbon, carbon sieve, silica gel, fumed silica, silica or mixtures thereof.

In another aspect, a multi-stage process such as a two-stage process for separation of removal a plurality of impurities from a feed gas stream is disclosed. The process entails contacting a feed gas stream having a plurality of impurities therein with a first sorbent during a first stage to remove a first one of the plurality of impurities from the feed gas stream to generate a first effluent stream having a lower amount of the first impurity than in the feed gas stream. The first effluent is contacted with a second sorbent in a second stage where the second sorbent may be the same or different from the first sorbent to remove a second one of the plurality of impurities from the first effluent to produce a second effluent having a lower amount of the second one of the plurality of impurities than in the first effluent stream. In the first stage the first sorbent is maintained at about 10° C. to about 130° C. and the gas feed stream is contacted with the first sorbent at a first flow rate GHSV of about 200 h⁻¹ to about 200,000 h⁻¹. In the second stage the second sorbent is maintained at about −10° C. to about 80° C. and the first effluent is contacted with the second sorbent at a second flow rate GHSV of about 200 h⁻¹ to about 2×10⁵h⁻¹. Impurities which may be removed include but are not limited to H₂S, COS, CO₂, NO₂, NO, N₂O, SO₂, SO₃, HCl, HF, HCN, NH₃, H₂O, C₂H₅OH, CH₃OH, HCHO, CHCl₃, CH₂Cl₂, CH₃Cl—, CS₂, C₄H₄S, CH₃SH, CH₃—S—CH₃ and mixtures thereof. Feed gas streams which may be employed include but are not limited to natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air and mixtures thereof. The sorbent which may be employed includes a first component for sorbing one or more impurities from the gas stream, and a second component comprising a porous support material for supporting the first component. The first component may be any of polyethyleneglycolamine (PEGA), polyethyleneimine (PEI), polyethanolamine (PEA), polyisopropanolamine (PIPA), polyalkylene glycol dimethyl ether (PAGDE), polyethylene glycol (PEG), n-methylpyrrolidinone (NMP), n-formylmorpholine (NFM), N-acetylmorpholine (NAM), propylene carbonate, sulfolane, or mixtures thereof, and the porous support material is selected from the group consisting of alumino-silicates, activated carbon, carbon sieve, silica gel, fumed silica, silica or mixtures thereof.

The sorbents may be prepared by loading any one or more of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH₃-philic polymer(s) or mixtures thereof, one or more of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH-philic compounds or mixtures thereof, as well as mixtures of those polymers and compounds on to porous materials such as mesoporous or macroporous materials. The sorbents may be employed over a wide range of temperatures to treat, such as, fuel gas streams. Typically, the sorbents may be employed at about 20° C. to about 130° C., preferably about 40° C. to about 110° C., more preferably about 60° C. to about 90° C. to remove CO₂ from gas streams such as natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air in both one-stage and multi-stage separation processes. The sorbents may be employed at about −10° C. to about 80° C., preferably about 5° C. to about 50° C., more preferably about 15° C. to about 40° C. to remove H₂S and COS from gas streams such as natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air during both one-stage and multi-stage separation processes such as two stage separation processes. The sorbents also may be employed at about −10° C. to about 100° C. to remove NO₂, NO, N₂O, SO₂, SO₃, HCl, HF, HCN, NH₃, H₂O, C₂H₅OH, CH₃OH, HCHO, CHCl₃, CH₂Cl₂, CH₃Cl—, CS₂, C₄H₄S, CH₃SH and CH₃—S—CH₃ from gas streams such as natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air and indoor air in both one-stage and multi-stage separation processes such as two-stage separation processes.

The sorbents may be regenerated over a wide range of temperatures. Typically, the sorbents may be regenerated at about 20° C. to about 130° C., preferably about 50° C. to about 120° C., more preferably about 75° C. to about 110° C. by using vacuum or a purge gas such as nitrogen, air or mixtures thereof.

The sorbents may be employed in processes such as one-stage and multi-stage processes to remove any one or more of H₂S, COS, CO₂, NO₂, NO, N₂O, SO₂, SO₃, HCl, HF, HCN, NH₃, H₂O, C₂H₅OH, CH₃OH, HCHO, CHCl₃, CH₂Cl₂, CH₃C₁, CS₂, C₄H₄S, CH₃SH and CH₃—S—CH₃ from gas streams such as natural gas, coal/biomass gasification gas, biogas, landfill gas, coal mine gas, reformate gas, ammonia syngas, H₂ and oxo-syngas, Fe ore reduction gas, refinery process gases, indoor air, fuel cell anode fuel gas and cathode air by use of, such as, fixed-bed sorbers, fluidized-bed sorbers, moving-bed sorbers and rotating-bed sorbers. Multi-stage processes such as two-stage process may be employed to remove, separate and/or recover any one or more of CO₂, H₂S, NH₃, H₂O, CH₃—S—CH₃, COS, NO₂, NO, N₂O, SO₂, SO₃, HCl, HF, HCN, C₂H₅OH, CH₃OH, HCHO, CHCl₃, CH₂Cl₂, CH₃C₁, CS₂, C₄H₄S, and CH₃SH, respectively, from a gas stream which contains CO₂ and other harmful gases.

The resulting treated gases have sufficiently low levels of impurities such as CO₂, H₂S, NH₃, H₂O, CH₃—S—CH₃, COS, NO₂, NO, N₂O, SO₂, SO₃, HCl, HF, HCN, C₂H₅OH, CH₃OH, HCHO, CHCl₃, CH₂Cl₂, CH₃Cl, CS₂, C₄H₄S, and CH₃SH, typically less than about 2 ppm. The treated gases may be used in applications such as on-site and/or on-board hydrogen production devices. The treated gases also may be employed in, such as, solid oxide fuel cells (SOFCs), proton-exchange membrane fuel cells (PEMFCs), production of electricity, value-added chemicals, transportation fuels, manufacture of hydrogen and other gases, as well as manufacture of fertilizers and liquid hydrocarbons in, such as, refineries and manufacturing plants.

The two-stage separation process disclosed herein advantageously enables selective removal of a specific impurity during each stage of the process.

Having summarized the invention, the invention is described in detail below by reference to the following detailed description and non-limiting examples.

### DETAILED DESCRIPTION OF THE INVENTION

The sorbents generally entail any one or more of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH-phillic polymer or mixtures thereof, as well as any one or more of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH-philic compounds, or mixtures thereof, loaded onto a porous solid material such as a mesoporous solid, macroporous solid, microporous solid or mixtures thereof.

The sorbents may be prepared by forming a slurry of a porous material in an alcoholic or aqueous solution that contains one or more of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH-philic polymers or mixtures thereof, as well as any one or more of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH-philic compounds or mixtures thereof. The slurry then is dried in air and further dried in vacuum or under a carrier gas. Air drying may be performed at about 0° C. to about 110° C., preferably about 20° C. to about 100° C., more preferably about 40° C. to about 100° C.

The resulting dried sorbent is packed into a fixed-bed sorber such as a column such as a glass/quartz/stainless steel type column or a fluidized-bed sorber. The sorbent then is further dried in vacuum or under flow of a carrier gas such as N₂, He, Ar or mixtures thereof, preferably N₂ at about 40° C. to about 120° C., preferably about 70° C. to about 110° C., more preferably about 80° C. to about 105° C. Where nitrogen gas is used as a carrier gas, the nitrogen gas flow may be at an hour space velocity of about 200 h⁻¹ to about 10,000 h⁻¹, preferably about 400 h⁻¹ to about 3,000 h⁻¹, more preferably about 900 h⁻¹ to about 2,000 h⁻¹ for about 2 hr to about 24 hr, preferably about 8 hr to about 20 hr, more preferably about 10 hr to about 12 hr in a fixed-bed sorber.

Polymers which may be employed to provide useful alcoholic or aqueous solutions of polymer(s) and/or compound(s) include, but are not limited to, polymers and compounds, and mixtures thereof which contain one or more of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH-philic functional groups such as polyethylenimine (PEI), polyethyleneglycolamine (PEGA), polyethanolamine (PEA), polyisopropanolamine (PIPA), polyalkylene glycol dimethyl ether (PAGDE), polyethylene glycol (PEG), n-methylpyrrolidinone (NMP), n-formylmorpholine (NFM), N-acetylmorpholine (NAM), propylene carbonate, sulfolane, modified polymers of the polymers listed above or mixtures thereof. As used herein, modified polymer is understood as a polymer loaded with one or more other polymers listed above. Alcohols which may be employed to provide useful alcoholic solutions of polymer include but are not limited to lower alkanols such as methanol, ethanol, propanol, butanol or mixtures thereof. Porous materials which may be dispersed in the alcoholic or aqueous solutions of polymer include but are not limited to mesoporous, microporous and macroporous materials such as MCM-41, MCM-48, KIT-6, SBA-15, activated carbon, carbon sieves, silica gel, fumed silica such as Cab-O-Sil, silica or mixtures thereof.

MCM-41 is an alumino silicate that has a SiO₂/Al₂O₃ molar ratio of about 20 or more. MCM-41 is prepared according to the procedure of Reddy and Song, Synthesis of mesoporous molecular sieves: Influence of aluminum source on Al incorporation in MCM-41, Catal. Lett., 1996, 36, pp. 103-109; Reddy et al., Synthesis of Mesoporous Zeolites and Their Application for Catalytic Conversion of Polycyclic Aromatic Hydrocarbons, Catalysis Today, 1996, 31(1), pp. 137-144, the teachings of which are incorporated by reference herein in their entirety. Another method that may be used is disclosed in U.S. Pat. No. 5,098,684, the teachings of which are incorporated herein in their entirety by reference.

MCM-48 is an alumino silicate that has a SiO₂/Al₂O₃ molar ratio of about 10 or more. MCM-48 may be prepared by dissolving 30 g tetraethyl orthosilicate in 150 g deionized water at 40° C. while stirring for 40 min. Then 2.88 g sodium hydroxide and 0.5 g ammonium fluoride are added. After stirring for 1 h, 31.8 g cetyltrimethylammonium bromide is added and stirred at 40° C. for 1 h. The resulting solution is heated to 120° C. for 24 h to yield a solid. The solid is recovered by filtration, washed, dried at 100° C. overnight and calcined at 550° C. for 6 h to yield MCM-48. The MCM-48 may be ground to yield micron or lesser sized particles.

KIT-6 is an alumino silicate that has a SiO₂/Al₂O₃ molar ratio of about 10 or more. KIT-6 may be made by dissolving 24 g of triblock copolymer Pluronic P123 (MW 5800 from Aldrich) in 912.6 ml of 0.5 M hydrochloric acid. Then 24 g butanol is added with stirring at 35° C. for 1 h. Then, 51.6 g tetraethyl orthosilicate is added and the resulting solution is stirred at 35° C. for 24 h and further heated to 100° C. for 24 h to produce a solid. The solid is recovered by filtration, washed, dried at 100° C. overnight and calcined at 550° C. for 6 h to yield KIT-6. The KIT-6 may be ground to yield micron or lesser sized particles.

SBA-15 is made by mixing 2.4 g of triblock copolymer Pluronic P123 (MW 5800 from Aldrich) and 5.1 g tetraethyl orthosilicate in 75 ml of 2M hydrochloric acid while stirring at 40° C. for 20 h. The resulting solution is heated to 100° C. for 24 h to produce a solid. The solid is recovered by filtration, washed, dried at 100° C. overnight and calcined at 550° C. for 6 h to yield SBA-15. The SBA-15 may be ground to yield micron or lesser sized particles.

Mesoporous activated carbon is commercially available from a variety of sources such as Calgon or Kansai Coke & Chemicals Co. Cab-O-Sil is a fumed silica available from a variety of sources such as Riedel-de Haën. Silica gel is commercially available from a variety of sources such as Aldrich.

The amount of polymer in any of the alcoholic or aqueous polymer solutions may vary over a wide range. Typically, the polymer may be present in an amount of about 0.5 wt. % to about 40 wt. %, preferably about 2 wt. % to about 35 wt. %, more preferably about 4 wt. % to about 30 wt. % based on the weight of the solution. The amount of porous material which may be dispersed in any of the alcoholic or aqueous solutions of polymer also may vary over a wide range. Typically, the porous material may present in an amount of about 0.5 wt. % to about 40 wt. %, preferably about 2 wt. % to about 35 wt. %, more preferably about 4 wt. % to about 30 wt % based on the weight of the solution.

The amount of polymer(s) loaded onto the porous material also may vary over a wide range. Typically, the wt. percent loading of polymer (wt. (polymer)/wt. (polymer+porous material)×100%) may be about 10 wt. % to about 90 wt. %, preferably about 20 wt. % to about 80 wt. % of solid content, more preferably about 30 wt. % to about 70 wt. %.

The solids content of the slurries of porous material in the polymeric solution also may vary over a wide range. Typically, the slurries may have about 10% to about 40% solids content, preferably about 12% to about 30% solids content, more preferably about 14% to about 25% solids content.

The sorbents may be employed in a one-stage process to separate, such as H₂S, COS, CO₂, NO₂, NO, N₂O, SO₂, SO₃, HCl, HF, HCN, NH₃, H₂O, C₂H₅OH, CH₃OH, HCHO, CHCl₃, CH₂Cl₂, CH₃C₁, CS₂, C₄H₄S, CH₃SH and CH₃—S—CH₃ from gas streams such as natural gas, coal/biomass gasification gas, biogas, landfill gas, coal mine gas, reformate gas, ammonia syngas, H₂ and oxo-syngas, Fe ore reduction gas, refinery process gases, indoor air, fuel cell anode fuel gas and cathode air. The sorbent, when employed in a one-stage process, may be used with, for example, a fluidized-bed system, with a moving-bed system or with a fixed-bed sorption system which employs a pair of fixed-bed sorbers which may be operated in parallel and cyclically. In this aspect, a gas stream such as a fuel gas is passed through one of the sorbers to contact the sorbent while the second sorber is undergoing regeneration. When the first sorber is spent, the gas stream is redirected to the second sorber while the first sorber is being regenerated.

In a one stage process, separation of CO₂, H₂S, NH₃, H₂O, CH₃—S—CH₃, COS, NO₂, NO, N₂O, SO₂, SO₃, HCl, HF, HCN, C₂H₅OH, CH₃OH, HCHO, CHCl₃, CH₂Cl₂, CH₃Cl, CS₂, C₄H₄S, and CH₃SH from a gas stream such as natural gas, coal/biomass gasification gas, biogas, landfill gas, coal mine gas, reformate gas, ammonia syngas, H₂ and oxo-syngas, Fe ore reduction gas, refinery process gases, indoor air, fuel cell anode fuel gas and cathode air may be performed at about −10° C. to about 80° C., preferably about 5° C. to about 50° C., more preferably about 10° C. to about 40° C. The gas hourly space velocity (GHSV) of the gas stream that is passed through the sorbents may be about 200 h⁻¹ to about 200,000 h⁻¹, preferably about 400 h⁻¹ to about 20,000 h⁻¹, more preferably about 900 h⁻¹ to about 10,000 h⁻¹. Regeneration of the spent sorbent may be performed at about 20° C. to about 150° C., preferably about 50° C. to about 120° C., more preferably about 75° C. to about 110° C. with a purge gas such as N₂ or with vacuum.

The sorbents also may be used in multi-stage processes such as two-stage processes which employ, such as, fixed-bed sorbers, moving-bed sorbers or fluidized-bed sorbers to remove components such as H₂S, COS, CO₂, NO₂, NO, N₂O, SO₂, SO₃, HCl, HF, HCN, NH₃, H₂O, C₂H₅OH, CH₃OH, HCHO, CHCl₃, CH₂Cl₂, CH₃C₁, CS₂, C₄H₄S, CH₃SH and CH₃—S—CH from gas streams such as natural gas, coal/biomass gasification gas, biogas, landfill gas, coal mine gas, reformate gas, ammonia syngas, H₂ and oxo-syngas, Fe ore reduction gas, refinery process gases, indoor air, fuel cell anode fuel gas and cathode air.

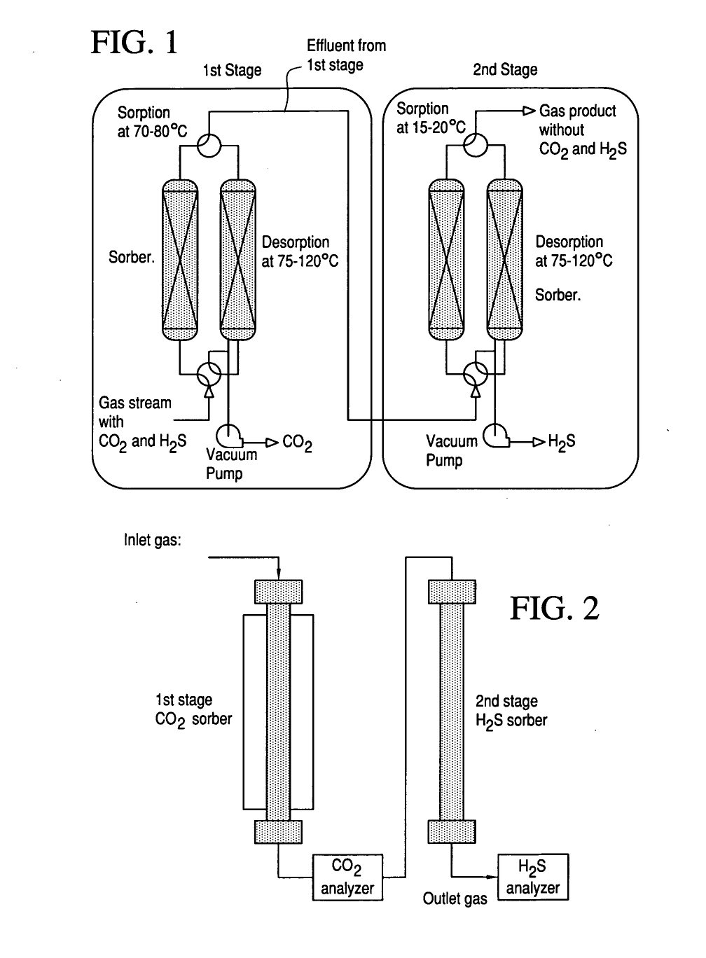

Multi-stage separation processes such as two stage separation processes for removing and recovering H₂S and CO₂, respectively, may be performed with an apparatus such as that shown in any of FIG. 1 and FIG. 2 that employ fixed-bed sorbers. It is to be understood, however, that the apparatus shown in each of FIGS. 1 and 2 are merely illustrative and that two stage separation processes are not limited to use of fixed-bed sorbers. Multi-stage processes such as two-stage processes may be used to separate and recover undesirable gases or sorption only of those gases. In a two stage process where sorption and desorption (regeneration) are performed, the apparatus of FIG. 1 may be employed.

The apparatus of FIG. 2 includes two sorption columns in series. The volume of the sorber bed of the first column may vary, and in one aspect, is 5.7 ml. The volume of the sorber bed of the second column also may vary, and in one aspect is 3.5 ml. A gas chromatograph (SR18610C) with a thermal conductive detector (TCD) is connected to the outlet of a first column to measure CO₂ concentration of the treated fuel gas effluent from the first stage. A sensor for measuring impurity concentration in the treated gas effluent may be connected to the outlet of the second column in the second stage. Where it is desired to measure the concentration of H₂S, a total sulfur analyzer such as (Antek 9000NS) may be connected to the outlet of the second column.

In stage 1 of a multi-stage process such as a two-stage process as shown in FIG. 1, a pair of sorbers such as fluidized-bed sorbers which employ porous sorbents are aligned such as in parallel and operate cyclically. In stage 1 of the two stage process, the sorbers may operate at about 10° C. to about 130° C., preferably about 30° C. to about 120° C., more preferably about 30° C. to about 100° C. to remove CO₂, NO, NO₂, SO₂, SO₃, HCl, or HF from a gas stream such as natural gas, coal/biomass gasification gas, biogas, landfill gas, coal mine gas, reformate gas, ammonia syngas, H₂ and oxo-syngas, Fe ore reduction gas, refinery process gases, indoor air, fuel cell anode fuel gas and cathode air. Gas hourly space velocity (GHSV) of gas streams such as natural gas, coal/biomass gasification gas, biogas, landfill gas, coal mine gas, reformate gas, ammonia syngas, H2 and oxo-syngas, Fe ore reduction gas, refinery process gases, indoor air, fuel cell anode fuel gas and cathode air as well as other fuel gas streams through the sorbers may be about 200 h⁻¹ to about 2.0×10⁵ h⁻¹, preferably about 400 h⁻¹ to about 2.0×10⁴ h⁻¹, more preferably about 500 h⁻¹ to about 1.0×10⁴ h^{-1.}

In stage 2 of the two stage process, the first one of the second pair of sorbers may operate at about −10° C. to about 80° C., preferably about 5° C. to about 50° C., more preferably about 10° C. to about 40° C. The sorbents employed in the second pair of sorbers may have a packing density of about 0.1 gms/cc to about 0.6 gms/cc, preferably about 0.2 gms/cc to about 0.5 gms/cc, more preferably about 0.3 gms/cc to about 0.5 gms/cc. The treated fuel gas streams generated in stage 1 may be passed through the sorbers employed in stage 2 at a GHSV of about 200 h⁻¹ to about 2.0×10⁵h⁻¹, preferably about 400 h⁻¹ to about 2.0×10⁴ h^{-l} more preferably about 600 h⁻¹ to about 1.0×10⁴ h⁻¹ to remove any of H₂S, COS, CO₂, NO₂, NO, N₂O, SO₂, SO₃, HCl, HF, HCN, NH₃, H₂O, C₂H₅OH, CH₃OH, HCHO, CHCl₃, CH₂Cl₂, CH₃C₁, CS₂, C₄H₄S, CH₃SH and CH₃—S—CH or mixtures thereof from the treated gas effluent of stage 1.

The sorbers in FIG. 1 may be made of metal, glass or polymer. During cyclic operation, the first one of the first pair of sorbers is used to remove one or more impurities such as CO₂, H₂S, NH₃, H₂O, CH₃—S—CH₃, COS, NO₂, NO, N₂O, SO₂, SO₃, HCl, HF, HCN, C₂H₅OH, CH₃OH, HCHO, CHCl₃, CH₂Cl₂, CH₃C₁, CS₂, C₄H₄S, and CH₃SH from a gas stream such as natural gas, coal/biomass gasification gas, biogas, landfill gas, coal mine gas, reformate gas, ammonia syngas, H₂ and oxo-syngas, Fe ore reduction gas, refinery process gases, indoor air, fuel cell anode fuel gas and cathode air while the second sorber is undergoing regeneration. When the first one of the first pair of sorbers is spent, the second one of the first pair of sorbers is used to treat the fuel gas stream to remove any one or more impurities such as CO₂, H₂S, NH₃, H₂O, CH₃—S—CH₃, COS, NO₂, NO, N₂O, SO₂, SO₃, HCl, HF, HCN, C₂H₅OH, CH₃OH, HCHO, CHCl₃, CH₂Cl₂, CH₃C₁, CS₂, C₄H₄S, and CH₃SH, while the first sorber is undergoing regeneration. The first sorber then again is used when the second sorber is spent. This cyclic process may be repeated. The sorbents employed in the sorbers used in stage 1 may have a wide range of packing densities. Typical packing densities may be about 0.1 gms/cc to about 0.6 gms/cc, preferably about 0.2 gms/cc to about 0.5 gms/cc, more preferably about 0.3 gms/cc to about 0.5 gms/cc.

Regeneration of the sorbers employed in stage 1 may be performed by heating the sorbents to about 20° C. to about 130° C., preferably about 50° C. to about 120° C., more preferably about 75° C. to about 115° C. for about 0.3 hr to about 24 hr, preferably about 0.5 hr to about 10 hr, more preferably about 0.5 hr to about 5 hr in the presence of vacuum or a purge gas such as nitrogen, air or mixtures thereof.

Regeneration of the sorbers employed in stage 2 may be performed by heating the sorbent bed to about 20° C. to about 130° C., preferably about 50° C. to about 120° C., more preferably about 75° C. to about 110° C. for about 0.3 hr to about 24 hr, preferably about 0.5 hr to about 10 hr, more preferably about 0.5 hr to about 5 hr in the presence of a gas such as nitrogen, air or vacuum.

Manufacture of the sorbents and their use is further illustrated below by reference to the following non-limiting examples.

Examples 1-11 illustrate manufacture of various porous sorbents

### EXAMPLE 1

### PEI(50)/SBA-15 (Loading 50 wt. % of PEI on SBA-15)

4.0 g of polyethylenimine (PEI) that has a molecular weight (MW) of 423 g/mol is dissolved in 32 g methanol at room temperature under stirring for 30 min to prepare an alcoholic solution of the polymer. Then 4.0 g of SBA-15 having an average particle size of 1 μm is added to the solution and stirred at room temperature for 8 h to produce a slurry. The slurry is further stirred in air at room temperature for 10 hr to produce a pre-dried sorbent. The pre-dried sorbent is placed into a glass column and dried at 100° C. under nitrogen (99.999%) flow of 100 mL/min for 12 h. The resulting sorbent has a BET surface area of 80 m²/g and pore volume of 0.20 cm³ g⁻¹ as measured by N₂ physisorption at −198° C. in a Micromeritics ASPS 2010 surface area and porosity analyzer.

### EXAMPLE 2

### PEI(15)/SBA-15

The procedure of example 1 is followed except that 0.71 gm of PEI is used to yield 15 wt % loading of PEI.

### EXAMPLE 3

### PEI(30)/SBA-15

The procedure of example 1 is followed except that 1.71 gm of PEI is used to yield 30 wt % loading of PEI.

### EXAMPLE 4

### PEI(65)/SBA-15

The procedure of example 1 is followed except that 7.43 gm of PEI is used to yield 65 wt % loading of PEI.

### EXAMPLE 5

### PEI(80)/SBA-15

The procedure of example 1 is followed except that 16.0 gm of PEI is used to yield 80 wt % loading of PEI.

### EXAMPLE 6

### PEI(50)/MCM-48

The procedure of example 1 is followed except that 4.0 gm of MCM-48 is substituted for SBA-15. The prepared sorbent has a BET surface area of 13 m²/g and pore volume of 0.02 cm³ g⁻¹ as measured by the N₂ physisorption technique.

### EXAMPLE 7

### PEI(50)/MCM-41

The procedure of example 1 is followed except that 4.0 gm of MCM-41 is substituted for SBA-15 and the flow rate of nitrogen is 50 mL/min. The prepared sorbent has a BET surface area of 11 m²/g and pore volume of 0.03 cm³ g⁻¹ measured by N₂ physisorption technique.

### EXAMPLE 8

### PEI(50)/KIT-6

The procedure of example 1 is followed except that 4.0 gm of KIT-6 is substituted for SBA-15.

### EXAMPLE 9

### PEI(50)/Cab-O-Sil

The procedure of example 1 is followed except that 4.0 gm of Cab-O-Sil is substituted for SBA-15.

### EXAMPLE 10

### PEG(50)/SBA-15

The procedure of example 1 is followed except that 4.0 gm of polyethylene glycol (PEG, MW of 400, Aldrich) is substituted for PEI.

### EXAMPLE 11

### PEG(20)-PEI(50)/SBA-15

4.0 g of polyethylene glycol (PEG, MW of 400, Aldrich) and 10.0 g of polyethyleneimine (PEI, MW 423) are dissolved in 32 g methanol at room temperature under stirring for 30 min to prepare an alcoholic solution of the polymers. Then 6.0 g of SBA-15 with particle size of 1 μm is added to the solution and stirred at room temperature for 8 h to produce a slurry. The slurry is further stirred at room temperature for 10 hr to produce a pre-dried nanoporous sorbent. The pre-dried sorbent is placed into a glass column and dried at 100° C. under nitrogen (99.999%) flow of 100 mL/min for 12 h.

Examples 12-27 illustrate use of the sorbents in one-stage processes to remove H₂S from gas streams.

### EXAMPLE 12

### Removal of H₂S from a Model Fuel Gas that has 4000 ppmv H₂S Over PEI(50)/SBA-15 of Example 1 at 22° C.

The sorption separation of H₂S from a model fuel gas that has 4000 ppmv H₂S is carried out at atmospheric pressure and 22° C. in a fixed-bed system formed of a straight glass tube that has an inner diameter of 9.5 mm and length of 520 mm. Tubing and fittings coated with a sulfur inert material (purchased from Restek Corp.) are employed in the system. 1.0 g of PEI(50)/SBA-15 is placed into the center of the column to form a bed that has a thickness of 50 mm. Residual space in the column is filled with inert glass beads. Before a model gas is passed through the sorbent bed, the bed is heated to 100° C. in nitrogen at a GHSV of 1685 h⁻¹ (flow rate, 100 mL/min) and held overnight and cooled to room temperature (22° C.).

A model fuel gas that contains 4000 ppmv of H₂S and 20 vol % of H₂ in N₂ which simulates a dry coal/biomass gasification gas of coal/biomass-fired IGCC power plants then is passed through the sorption bed at a GHSV of 674 h⁻¹. The model fuel gas is prepared by blending ultra-high pure (UHP) hydrogen, nitrogen (99.999%) and a H₂S—N₂ mixture gas that contains 1.00 vol % H₂S gas in UHP nitrogen (both purchased from GT&S Inc.). The breakthrough capacity (“Cap (BT)”) of the sorbent is calculated according to equation 1

$$Cap ( BT ) = \frac{BT \times FR \times {C}_{{H}_{2} S}^{in} \times {10}^{- 6}}{{V}_{mol} \times W} , \qquad ( 1 )$$

where:

Cap (BT) is mmol-H₂S/g sorbent at STP,

BT is the breakthrough time (min) when the H₂S concentration in the effluent measured at the outlet of the bed reaches 2 ppmv,

FR is the flow rate (mL/min) of the model fuel gas,

Vₘₒₗ is the molar volume of the fuel gas (24.4 mL/mmol at standard conditions), W is the weight of the sorbent (in grams) and Cⁱⁿ_{H}_{₂}_{S} is the H₂S concentration in the untreated model fuel gas.

The concentration of H₂S in the effluent is measured by an on-line ANEK 9000NS Sulfur Analyzer until the sorbent is saturated, as determined by the time when the concentration of H₂S in the effluent gas reaches a concentration that is the same as that in the model fuel feed gas. The resulting data is plotted to generate a breakthrough curve. The saturation capacity of the sorbent (denoted as Cap (S), mmol-H₂S/g, STP) is calculated by integration of the area between the line for the initial concentration of H₂S in the fuel gas and the breakthrough curve until saturation. The breakthrough capacity and saturation capacity of H₂S are 0.79 mmol/g and 1.98 mmol/g, respectively, as shown in Table 1.

### EXAMPLE 12A

The process of example 12 is employed except that dry coal/biomass gasification gas of coal/biomass-fired IGCC power plants is substituted for the model gas.

### EXAMPLE 13

### Removal of H₂S from a Model Fuel Gas Over PEI(15)/SBA-15

The procedure of example 12 is followed except that 1.0 gm of the PEI(15)/SBA-15 sorbent of example 2 is substituted for PEI(50)/SBA-15. The breakthrough capacity and saturation capacity are 0.019 mmol/g and 0.090 mmol/g, respectively, as shown in Table 1.

### EXAMPLE 13A

The process of example 13 is employed except that dry coal/biomass gasification gas of coal/biomass-fired IGCC power plants is substituted for the model gas.

### EXAMPLE 14

### Removal of H₂S from a Model Fuel Gas Over PEI(30)/SBA-15

The procedure of example 12 is followed except that 1.0 gm of the PEI(30)/SBA-15 sorbent of example 3 is substituted for PEI(50)/SBA-15. The breakthrough capacity and saturation capacity are 0.26 mmol/g and 0.68 mmol/g, respectively, as shown in Table 1.

### EXAMPLE 14A

The process of example 14 is employed except that dry coal/biomass gasification gas of coal/biomass-fired IGCC power plants is substituted for the model gas.

### EXAMPLE 15

### Removal of H₂S from a Model Fuel Gas Over PEI(65)/SBA-15

The procedure of example 12 is followed except that 1.5 gm of the PEI(65)/SBA-15 sorbent of example 4 is substituted for PEI(50)/SBA-15. The breakthrough capacity and saturation capacity are 0.072 mmol/g and 3.02 mmol/g, respectively, as shown in Table 1.

### EXAMPLE 15A

The process of example 15 is employed except that dry coal/biomass gasification gas of coal/biomass-fired IGCC power plants is substituted for the model gas.

### EXAMPLE 16

### Removal of H₂S from a Model Fuel Gas Over PEI(80)/SBA-15

The procedure of example 12 is followed except that 1.0 gm of the PEI(80)/SBA-15 sorbent of example 5 is substituted for PEI(50)/SBA-15. The breakthrough capacity and saturation capacity are 0.018 mmol/g and 1.00 mmol/g, respectively, as shown in Table 1.

### EXAMPLE 16A

The process of example 16 is employed except that dry coal/biomass gasification gas of coal/biomass-fired IGCC power plants is substituted for the model gas.

TABLE 1

| | | Cap (BT) | Cap (S) |
|---|---|---|---|
| Example | Sample | (mmol/g-sorbent) | (mmol/g-sorbent) |
| 12 | PEI(50)/SBA-15 | 0.79 | 1.98 |
| 13 | PEI(15)/SBA-15 | 0.019 | 0.090 |
| 14 | PEI(30)/SBA-15 | 0.26 | 0.68 |
| 15 | PEI(65)/SBA-15 | 0.072 | 3.02 |
| 16 | PEI(80)/SBA-15 | 0.018 | 1.00 |

### EXAMPLE 17

### Removal of H₂S from a Model Fuel Gas Over PEI(50)/SBA-15 at 50° C.

The procedure of example 12 is followed except that the sorption temperature of 50° C. is employed instead of 22° C. The breakthrough capacity and saturation capacity are 0.12 mmol/g and 0.36 mol/g, respectively, as shown in Table 2.

### EXAMPLE 17A

The process of example 17 is employed except that dry coal/biomass gasification gas of coal/biomass-fired IGCC power plants is substituted for the model gas.

### EXAMPLE 18

### Removal of H₂S from a Model Fuel Gas Over PEI(50)/SBA-15 at 75° C.

The procedure of example 12 is followed except that a sorption temperature of 75° C. is employed instead of 22° C. The breakthrough capacity and saturation capacity are 0.037 mmol/g and 0.11 mmol/g, respectively, as shown in Table 2.

### EXAMPLE 18A

The process of example 18 is employed except that dry coal/biomass gasification gas of coal/biomass-fired IGCC power plants is substituted for the model gas.

TABLE 2

| | Temp. | Cap (BT) | Cap (S) |
|---|---|---|---|
| Example | (° C.) | (mmol/g-sorbent) | (mmol/g-sorbent) |
| 17 | 50 | 0.12 | 0.36 |
| 18 | 75 | 0.037 | 0.11 |

### EXAMPLE 19

### Removal of H₂S from a Model Fuel Gas Over PEI(50)/MCM-48

The procedure of example 12 is followed except that 1.0 gm of the PEI(50)/MCM-48 sorbent of example 6 is substituted for PEI(50)/SBA-15. The breakthrough capacity and saturation capacity are 0.81 mmol/g and 1.84 mmol/g, respectively, as shown in Table 3.

### EXAMPLE 19A

The process of example 19 is employed except that dry coal/biomass gasification gas of coal/biomass-fired IGCC power plants is substituted for the model gas.

### EXAMPLE 20

### Removal of H₂S from a Model Fuel Gas Over PEI(50)/MCM-41

The procedure of example 12 is followed except that 1.0 gm of the PEI(50)/MCM-41 sorbent of example 7 is substituted for PEI(50)/SBA-15. The breakthrough capacity and saturation capacity are 0.46 mmol/g and 1.84 mol/g, respectively, as shown in Table 3.

### EXAMPLE 20A

The process of example 20 is employed except that dry coal/biomass gasification gas of coal/biomass-fired IGCC power plants is substituted for the model gas.

### EXAMPLE 21

### Removal of H₂S from a Model Fuel Gas Over PEI(50)/KIT-6

The procedure of example 12 is followed except that 2.0 gm of the PEI(50)/KIT-6 sorbent of example 8 is substituted for PEI(50)/SBA-15 and a 60 mL/min flow rate of the model fuel gas is used. The breakthrough capacity and saturation capacity are 0.47 mmol/g and 4.26 mmol/g, respectively, as shown in Table 3.

### EXAMPLE 21A

The process of example 21 is employed except that dry coal/biomass gasification gas of coal/biomass-fired IGCC power plants is substituted for the model gas.

TABLE 3

| | | Cap (BT) | Cap (S) |
|---|---|---|---|
| Example | Sample | (mmol/g-sorbent) | (mmol/g-sorbent) |
| 19 | PEI(50)/MCM-48 | 0.81 | 1.84 |
| 20 | PEI(50)/MCM-41 | 0.46 | 1.84 |
| 21 | PEI(50)/KIT-6^{a} | 0.47 | 2.13 |

### EXAMPLE 22

### Removal of H₂S from a Model Fuel Gas Over PEG(20)-PEI(50)/SBA-15

The procedure of example 12 is followed except that 1.4 gm of the PEG(20)-PEI(50)/SBA-15 of example 11 is substituted for PEI(50)/SBA-15 and a 60 mL/min flow rate of the model fuel gas is used. The breakthrough capacity and saturation capacity are 0.46 mmol/g and 1.84 mol/g, respectively.

### EXAMPLE 22A

The process of example 22 is employed except that dry coal/biomass gasification gas of coal/biomass-fired IGCC power plants is substituted for the model gas.

### EXAMPLE 23

### Removal of H₂S from a Moist Model Gas Over PEI(50)/SBA-15

The procedure of example 12 is followed except that 0.2034 g of the PEI(50)/SBA-15 of example 1 is used and a moist model gas that contains 7300 ppmv H₂S, 20 vol. % H₂ and 3 vol. % of H₂O which simulates a moist coal/biomass gasification gas of coal/biomass-fired IGCC power plants is used. A GHSV of 8182 h⁻¹ is used.

The moist model gas is prepared by blending 7 vol. % ultra-high pure (UHP) nitrogen (99.999%), 20 vol. % UHP hydrogen and 73 vol. % of a H₂S—N₂ mixture gas that contains 1.00 vol % H₂S gas (purchased from GT&S Inc.). The resulting gas mixture is passed through a water bubbler at 22° C. to introduce 3 vol. % of H₂O into the gas mixture.

The breakthrough capacity and saturation capacity are 1.41 mmol/g and 9.57 mmol/g, respectively.

### EXAMPLE 23A

The process of example 23 is employed except that moist coal/biomass gasification gas of coal/biomass-fired IGCC power plants is substituted for the model gas.

### EXAMPLE 24

### Desorption of H₂S from Saturated PEI(50)/SBA-15 at Room Temperature

The adsorption procedure of example 12 is followed. When the H₂S concentration at the outlet of the bed equals the initial concentration of H₂S in the fuel gas, the sorbent is deemed saturated by H₂S. The gas stream supplied to the bed then is switched to UHP nitrogen (99.999%) at a flow rate of 100 mL/min at room temperature (22° C.) to cause desorption of H₂S from the sorbent. The H₂S concentration in the effluent gas is detected by the on-line sulfur analyzer used in example 12.

The desorption capacity of the saturated sorbent of example 12 (denoted as Cap (D), mmol-H₂S/g, STP) is calculated by measuring the amount of H₂S released from the sorbent as a function of time to generate a desorption curve during regeneration. The time period for measurement begins when the carrier gas is introduced and ends when no sulfur can be detected by the on-line sulfur analyzer. Integration of the area under the desorption curve equals the desorption capacity of the sorbent. The desorption capacity of the sorbent is 1.68 mmol/g.

### EXAMPLE 25

### Desorption of H₂S from Saturated PEI(50)/SBA-15 at 75° C.

The procedure of example 24 is followed except that the desorption temperature is increased to 75° C. as soon as N₂ gas is introduced and is held at 75° C. to perform the desorption. The desorption capacity is 1.66 mmol/g.

### EXAMPLE 26

### Regeneration of Saturated PEI(50)/SBA-15 of Example 12

The procedure of example 25 is followed except that the initial H₂S concentration of the model fuel gas is 7300 ppmv, the flow rate of the model fuel gas is 60 mL/min, and 0.2034 g of PEI(50)/SBA-15 is used. The sorption-desorption cycle of Example 24 is repeated for 10 cycles. The employed model fuel gas which simulates a dry coal/biomass gasification gas of coal/biomass-fired IGCC power plants is prepared by blending 7 vol. % ultra-high pure (UHP) nitrogen (99.999%), 20 vol. % UHP hydrogen and 73 vol. % of H₂S—N₂ mixture gas that contains 1.00 vol % H₂S gas (purchased from GT&S Inc.). The saturation capacities of the sorbent after each sorption-desorption cycle are 2.53 mmol/g, 2.35 mmol/g, 2.40 mmol/g, 2.52 mmol/g, 2.49 mmol/g, 2.49 mmol/g, 2.45 mmol/g, 2.43 mmol/g, 2.49 mmol/g, and 2.47 mmol/g for cycles 1 to 10, respectively.

### EXAMPLE 27

### Regeneration of Saturated PEI(50)/MCM-41

The procedure of example 25 is followed except that 1.6 gm of PEI(50)/MCM-41 of example 7 is substituted for PEI(50)/SBA-15 and a model fuel gas that has a H₂S concentration of 9300 ppmv is used. The sorption-desorption regeneration cycle of Example 26 is repeated for 3 cycles. The model gas is prepared by blending 7 vol % ultra-high pure (UHP) nitrogen (99.999%) and 93 vol. % of H₂S—N₂ mixture gas that contains 1.00 vol % H₂S gas. The saturation capacity after regeneration is 2.43 mmol/g for each of the three cycles.

### EXAMPLE 28

### This Example Illustrates Use of Sorbents in One-Stage Process to Remove COS from a Model Gas that Simulates a Dry Coal/Biomass Gasification Gas of Coal/Biomass-Fired IGCC Power Plants

The sorptive separation of COS from a model fuel gas that simulates a dry coal/biomass gasification gas of coal/biomass-fired IGCC power plants is performed using a fixed-bed sorber formed of a straight stainless steel tube that has an inner diameter of 9.24 mm and length of 39.4 mm at atmospheric pressure. Tubing and fittings coated with a sulfur inert material (purchased from Restek Corp.) are used.

0.78 g of PEI(50)/SBA-15 sorbent of example 1 is packed into the tube to form a sorption bed that has a bed height of 49.3 mm. Before the model gas is passed through the sorbent bed, the bed is heated to 100° C. in nitrogen at a GHSV of 2273 h⁻¹ (flow rate, 100 mL/min) and held overnight. The bed then is cooled to room temperature (22° C.), and a model gas that contains 80 ppmv of COS and 20 vol % of H₂ in N₂ which simulates a dry coal/biomass gasification gas of coal/biomass-fired IGCC power plants is introduced into the sorption bed at a GHSV of 2727 h⁻¹.

The model gas employed is prepared by blending 20 vol. % ultra-high pure (UHP) hydrogen (99.999%) and 80 vol. % of COS—N₂ mixture gas that contains 100 ppmv COS gas (both purchased from GT&S Inc.). When the COS concentration at the outlet of the tube equals the initial concentration of COS in the model gas, the sorbent is deemed saturated by COS. The feed gas then is switched to UHP nitrogen at a flow rate of 100 mL/min and the temperature is increased to 75° C. The COS concentration in the effluent gas stream is detected by an on-line ANTEK 9000NS Sulfur Analyzer.

The breakthrough capacity of the sorbent (denoted as Cap (BT), mmol-COS/g, STP) is calculated according to Equation (1A):

$$Cap ( BT ) = \frac{BT \times FR \times {C}_{COS}^{in} \times {10}^{- 6}}{{V}_{mol} \times W} , \qquad ( 1 A )$$

where

BT is the breakthrough time (min) when the COS concentration at the outlet of the sorber reaches 5 ppmv,

FR is the flow rate (mL/min) of the fuel gas,

Vₘₒₗ is the molar volume (24.4 mL/mmol at standard conditions) of the fuel gas, W is the weight of the sorbent (in grams) and

Cⁱⁿ_{COS} is the COS concentration in the model fuel gas (80 ppmv).

The saturation capacity (denoted as Cap (S), mmol-COS/g, STP) and breakthrough capacity are calculated as in example 12. The breakthrough capacity and saturation capacity of the sorbent for COS are 0.067 mmol/g and 0.63 mmol/g, respectively.

### EXAMPLE 28A

The process of example 28 is employed except that dry coal/biomass gasification gas of coal/biomass-fired IGCC power plants is substituted for the model gas.

Example 29-31 illustrate the use of sorbents in one-stage processes to remove CO₂ from fuel gas streams

### EXAMPLE 29

### Removal of CO₂ from a Model Fuel Gas Over the PEI(50)/SBA-15 Sorbent of Example 1

The sorption of CO₂ from a model fuel gas that simulates dry flue gas is carried out using a fixed-bed system formed of a straight glass tube that has an inner diameter of 9.5 mm and a length of 520 mm at atmospheric pressure. 1.0 g of PEI(50)/SBA-15 sorbent produced as in example 1 is placed into the tube to form a bed that has a bed height of 50 mm. The sorbent is heated to 100° C. in helium at a GHSV of 843 h⁻¹ (flow rate, 50 mL/min) and held overnight. After the bed is cooled to 75° C., a model fuel gas (purchased from GT&S Inc.) that contains 14.9 vol. % of CO₂ and 4.25 vol. % of O₂ in N₂ which simulates a dry flue gas of coal-fired electrical power plants is introduced into the sorption bed at a GHSV of 337 h⁻¹ (flow rate, 20 mL/min). When the CO₂ concentration in the effluent at the outlet of the tube equals the initial concentration of CO₂ in the model fuel gas, the sorbent is deemed saturated by CO₂. The model fuel gas then is switched to UHP helium (purchased from GT&S Inc.) at a flow rate of 50 mL/min and the bed is held at 75° C. to perform desorption and regeneration.

The CO₂ concentration in the effluent gas stream is detected by an on-line SRI gas chromatograph equipped with a thermal conductive detector (TCD) (detector limit is ca. 100 ppmv). The gases are separated by Molecular Sieve 5A and Porapak T columns.

The CO₂ breakthrough capacity of the sorbent (denoted as Cap (BT), mmol-CO₂/g, STP) is calculated according to equation (1B):

$$Cap ( BT ) = \frac{BT \times FR \times {C}_{{CO}_{2}}^{in} \times {10}^{- 2}}{{V}_{mol} \times W} , \qquad ( 1 B )$$

where

BT is the breakthrough time (min) when the CO₂ concentration at the outlet is 100 ppmv;

FR is the flow rate (mL/min) of the fuel gas;

Vₘₒₗ is the molar volume (24.4 mL/mmol at standard conditions) of the fuel gas; W is the weight of the sorbent (in grams) and

Cⁱⁿ_{CO}_{₂} is the CO₂ concentration of the untreated model fuel gas (14.9 vol. %).

The saturation capacity (denoted as Cap (S), mmol-CO₂/g, STP) and breakthrough capacity are calculated as in example 12. The breakthrough capacity and saturation capacity are 2.71 mmol/g and 3.19 mmol/g, respectively.

### EXAMPLE 29A

The process of example 29 is employed except that dry flue gas is substituted for the model gas.

### EXAMPLE 30

### Removal of CO₂ from a Model Fuel Gas Over the PEI(50)/MCM-48 of Example 6

The procedure of example 29 is followed except that 1.5 gm of the PEI(50)/MCM-48 sorbent of example 6 is substituted for PEI(50)/SBA-15. The breakthrough capacity and saturation capacity are 1.86 mmol/g and 2.40 mmol/g, respectively.

### EXAMPLE 30A

The process of example 30 is employed except that dry flue gas is substituted for the model gas.

### EXAMPLE 31

The sorption of CO₂ from a pure CO₂ gas and desorption of CO₂ is performed on a Micromeritics AutoChem 2910 instrument using a fixed-bed quartz reactor that has an inner diameter of 10 mm at atmospheric pressure. Then, 0.10 g of the PEI(50)/Cab-O-Sil sorbent is loaded into the reactor to form a sorbent bed (4 mm in height). The sorbent bed is heated to 100° C. in helium at a flow rate of 30 mL/min and held for 30 min at 100° C. The reactor then is cooled to 75° C. and 99% pure CO₂ gas is passed through the bed at a flow rate of 20 mL/min for 30 min. The bed then is cooled to 30° C. and temperature-programmed-desorption (TPD) is performed. Flowing carrier gas (UHP He, 50 mL/min) is used and the bed temperature is increased at the rate of 5° C./min from 30° C. to 110° C. The effluent CO₂ concentration is detected by a thermal conductive detector. The desorption curve then is plotted.

The saturation capacity of the sorbent (denoted as Cap (D), mmol-CO₂/g, STP) is calculated by measuring the amount of CO₂ evolved from the sorbent as a function of time to generate a desorption curve. The time period for measurement begins when the temperature begins to increase and ends when the final temperature is reached. Integration of the area under the desorption curve equals the saturation capacity of the sorbent. The saturation capacity is 3.92 mmol/g.

Examples 32-44 illustrate use of the sorbents in two-stage processes for removal of CO₂ and H₂S, respectively, from gas streams.

### EXAMPLE 32

### Two-Stage Process for Removal of CO₂ and H₂S, Respectively, from Gas Streams

The apparatus for two-stage sorption process for removing CO₂ and H₂S is shown in FIG. 2. The sorption column in the first stage is a glass column and is packed with 2.58 gm of the PEI(50)/MCM-41 sorbent of example 7. The sorption column employed in the second stage is packed with 1.56 g of the PEI(50)/MCM-41 of example 7.

A model fuel gas is passed through the sorption column employed in stage 1 of the apparatus shown in FIG. 2 at a flow rate of 60 ml/min (486 h⁻¹ GHSV) to remove CO₂ from the model fuel gas stream. The temperature of the sorption column employed in the first stage for removal of CO₂ is 75° C. The effluent generated by stage 1 then is passed through the sorption column employed in stage 2 at the flow rate of 60 mL/min (486 h⁻¹ GHSV) to remove H₂S from the model fuel gas stream. The temperature of the sorption column employed in the second stage is room temperature (22° C.).

The CO₂ concentration at the outlet of the first stage is analyzed by on-line gas chromatography and the H₂S concentration at the outlet of the second stage is measured by an on-line ANTEK 9000NS Sulfur Analyzer.

The model fuel gas includes 0.40 v % H₂S, 2.40 v % CO₂, and 20 v % of H₂ which simulates a coal/biomass gasification gas of coal/biomass-fired IGCC power plants. The model fuel gas is prepared by blending 77.2 v % ultra-high pure (UHP) nitrogen, 20 v % of ultra-high pure hydrogen (99.999%), 0.40 v % H₂S and 2.40 v % CO₂ (purchased from GT&S Inc.)

In the first stage, the CO₂ breakthrough time is 96 min, corresponding to a breakthrough capacity of 2.5 mmol-CO₂/g-sorbent. In the second stage, the H₂S breakthrough time is 85 min, corresponding to a breakthrough capacity of 0.8 mmol-H₂S/g-sorbent.

### EXAMPLE 32A

The process of example 32 is employed except that coal/biomass gasification gas of coal/biomass-fired IGCC power plants is substituted for the model gas.

### EXAMPLE 32B

The process of example 32 is employed except that natural gas is substituted for the model gas.

### EXAMPLE 32C

The process of example 32 is employed except that biogas is substituted for the model gas.

### EXAMPLE 32D

The process of example 32 is employed except that landfill gas is substituted for the model gas.

### EXAMPLE 32E

The process of example 32 is employed except that coal mine gas is substituted for the model gas.

### EXAMPLE 32F

The process of example 32 is employed except that reformate gas is substituted for the model gas.

### EXAMPLE 32G

The process of example 32G is employed except that ammonia syngas is substituted for the model gas.

### EXAMPLE 32H

The process of example 32 is employed except that hydrogen gas is substituted for the model gas.

### EXAMPLE 32I

The process of example 32 is employed except that iron ore reduction gas is substituted for the model gas.

### EXAMPLE 32J

The process of example 32 is employed except that indoor air is substituted for the model gas.

### EXAMPLE 32K

The process of example 32 is employed except that fuel cell anode fuel gas is substituted for the model gas.

### EXAMPLE 32L

The process of example 32 is employed except that cathode air gas is substituted for the model gas.

### EXAMPLE 33

The method of example 32 is followed except that 2.58 gm and 1.56 g of the sorbent of example 1 are employed in the first and second stages, respectively.

### EXAMPLE 33A

The process of example 33 is employed except that coal/biomass gasification gas of coal/biomass-fired IGCC power plants is substituted for the model gas.

### EXAMPLE 33B

The process of example 33 is employed except that natural gas is substituted for the model gas.

### EXAMPLE 33C

The process of example 33 is employed except that biogas is substituted for the model gas.

### EXAMPLE 33D

The process of example 33 is employed except that landfill gas is substituted for the model gas.

### EXAMPLE 33E

The process of example 33 is employed except that coal mine gas is substituted for the model gas.

### EXAMPLE 33F

The process of example 33 is employed except that reformate gas is substituted for the model gas.

### EXAMPLE 33G

The process of example 33 is employed except that ammonia syngas is substituted for the model gas.

### EXAMPLE 33H

The process of example 33 is employed except that hydrogen gas is substituted for the model gas.

### EXAMPLE 33I

The process of example 33 is employed except that iron ore reduction gas is substituted for the model gas.

### EXAMPLE 33J

The process of example 33 is employed except that indoor air is substituted for the model gas.

### EXAMPLE 33K

The process of example 33 is employed except that fuel cell anode fuel gas is substituted for the model gas.

### EXAMPLE 33L

The process of example 33 is employed except that cathode air gas is substituted for the model gas.

### EXAMPLE 34

The method of example 32 is followed except that 2.58 gm and 1.56 g of the sorbent of example 2 are employed in the first and second stages, respectively.

### EXAMPLE 34A

The process of example 34 is employed except that coal/biomass gasification gas of coal/biomass-fired IGCC power plants is substituted for the model gas.

### EXAMPLE 34B

The process of example 34 is employed except that natural gas is substituted for the model gas.

### EXAMPLE 34C

The process of example 34 is employed except that biogas is substituted for the model gas.

### EXAMPLE 34D

The process of example 34 is employed except that landfill gas is substituted for the model gas.

### EXAMPLE 34E

The process of example 34 is employed except that coal mine gas is substituted for the model gas.

### EXAMPLE 34F

The process of example 34 is employed except that reformate gas is substituted for the model gas.

### EXAMPLE 34G

The process of example 34 is employed except that ammonia syngas is substituted for the model gas.

### EXAMPLE 32H

The process of example 34 is employed except that hydrogen gas is substituted for the model gas.

### EXAMPLE 34I

The process of example 43 is employed except that iron ore reduction gas is substituted for the model gas.

### EXAMPLE 34J

The process of example 34 is employed except that indoor air is substituted for the model gas.

### EXAMPLE 34K

The process of example 34 is employed except that fuel cell anode fuel gas is substituted for the model gas.

### EXAMPLE 34L

The process of example 34 is employed except that cathode air gas is substituted for the model gas.

### EXAMPLE 35

The method of example 32 is followed except that 2.58 gm and 1.56 g of sorbent of example 3 are employed in the first and second stages, respectively.

### EXAMPLE 35A

The process of example 35 is employed except that coal/biomass gasification gas of coal/biomass-fired IGCC power plants is substituted for the model gas.

### EXAMPLE 35B

The process of example 35 is employed except that natural gas is substituted for the model gas.

### EXAMPLE 35C

The process of example 35 is employed except that biogas is substituted for the model gas.

### EXAMPLE 35D

The process of example 35 is employed except that landfill gas is substituted for the model gas.

### EXAMPLE 35E

The process of example 35 is employed except that coal mine gas is substituted for the model gas.

### EXAMPLE 35F

The process of example 35 is employed except that reformate gas is substituted for the model gas.

### EXAMPLE 35G

The process of example 35 is employed except that ammonia syngas is substituted for the model gas.

### EXAMPLE 35H

The process of example 35 is employed except that hydrogen gas is substituted for the model gas.

### EXAMPLE 35I

The process of example 35 is employed except that iron ore reduction gas is substituted for the model gas.

### EXAMPLE 35J

The process of example 35 is employed except that indoor air is substituted for the model gas.

### EXAMPLE 35K

The process of example 35 is employed except that fuel cell anode fuel gas is substituted for the model gas.

### EXAMPLE 35L

The process of example 35 is employed except that cathode air gas is substituted for the model gas.

### EXAMPLE 36

The method of example 32 is followed except that 2.58 gm and 1.56 g of sorbent of example 4 are employed in the first and second stages, respectively.

### EXAMPLE 36A

The process of example 36 is employed except that coal/biomass gasification gas of coal/biomass-fired IGCC power plants is substituted for the model gas.

### EXAMPLE 36B

The process of example 36 is employed except that natural gas is substituted for the model gas.

### EXAMPLE 36C

The process of example 36 is employed except that biogas is substituted for the model gas.

### EXAMPLE 36D

The process of example 36 is employed except that landfill gas is substituted for the model gas.

### EXAMPLE 36E

The process of example 36 is employed except that coal mine gas is substituted for the model gas.

### EXAMPLE 36F

The process of example 36 is employed except that reformate gas is substituted for the model gas.

### EXAMPLE 36G

The process of example 36G is employed except that ammonia syngas is substituted for the model gas.

### EXAMPLE 36H

The process of example 36 is employed except that hydrogen gas is substituted for the model gas.

### EXAMPLE 36I

The process of example 36 is employed except that iron ore reduction gas is substituted for the model gas.

### EXAMPLE 36J

The process of example 36 is employed except that indoor air is substituted for the model gas.

### EXAMPLE 36K

The process of example 36 is employed except that fuel cell anode fuel gas is substituted for the model gas.

### EXAMPLE 36L

The process of example 36 is employed except that cathode air gas is substituted for the model gas.

### EXAMPLE 37

The method of example 32 is followed except that 2.58 gm and 1.56 g of sorbent of example 5 are employed in the first and second stages, respectively.

### EXAMPLE 37A

The process of example 37 is employed except that coal/biomass gasification gas of coal/biomass-fired IGCC power plants is substituted for the model gas.

### EXAMPLE 37B

The process of example 37 is employed except that natural gas is substituted for the model gas.

### EXAMPLE 37C

The process of example 37 is employed except that biogas is substituted for the model gas.

### EXAMPLE 37D

The process of example 37 is employed except that landfill gas is substituted for the model gas.

### EXAMPLE 37E

The process of example 37 is employed except that coal mine gas is substituted for the model gas.

### EXAMPLE 37F

The process of example 37 is employed except that reformate gas is substituted for the model gas.

### EXAMPLE 37G

The process of example 37 is employed except that ammonia syngas is substituted for the model gas.

### EXAMPLE 37H

The process of example 37 is employed except that hydrogen gas is substituted for the model gas.

### EXAMPLE 37I

The process of example 37 is employed except that iron ore reduction gas is substituted for the model gas.

### EXAMPLE 37J

The process of example 37 is employed except that indoor air is substituted for the model gas.

### EXAMPLE 37K

The process of example 37 is employed except that fuel cell anode fuel gas is substituted for the model gas.

### EXAMPLE 37L

The process of example 37 is employed except that cathode air gas is substituted for the model gas.

### EXAMPLE 38

The method of example 32 is followed except that 2.58 gm and 1.56 g of Sorbent of example 6 are employed in the first and second stages, respectively.

### EXAMPLE 38A

The process of example 38 is employed except that coal/biomass gasification gas of coal/biomass-fired IGCC power plants is substituted for the model gas.

### EXAMPLE 38B

The process of example 38 is employed except that natural gas is substituted for the model gas.

### EXAMPLE 38C

The process of example 38 is employed except that biogas is substituted for the model gas.

### EXAMPLE 38D

The process of example 38 is employed except that landfill gas is substituted for the model gas.

### EXAMPLE 38E

The process of example 38 is employed except that coal mine gas is substituted for the model gas.

### EXAMPLE 38F

The process of example 38 is employed except that reformate gas is substituted for the model gas.

### EXAMPLE 38G

The process of example 38 is employed except that ammonia syngas is substituted for the model gas.

### EXAMPLE 38H

The process of example 38 is employed except that hydrogen gas is substituted for the model gas.

### EXAMPLE 38I

The process of example 38 is employed except that iron ore reduction gas is substituted for the model gas.

### EXAMPLE 38J

The process of example 38 is employed except that indoor air is substituted for the model gas.

### EXAMPLE 38K

The process of example 38 is employed except that fuel cell anode fuel gas is substituted for the model gas.

### EXAMPLE 38L

The process of example 38 is employed except that cathode air gas is substituted for the model gas.

### EXAMPLE 39

The method of example 32 is followed except that 2.58 gm and 1.56 gm of sorbent of example 8 are employed in the first and second stages, respectively.

### EXAMPLE 39A

The process of example 39 is employed except that coal/biomass gasification gas of coal/biomass-fired IGCC power plants is substituted for the model gas.

### EXAMPLE 39B

The process of example 39 is employed except that natural gas is substituted for the model gas.

### EXAMPLE 39C

The process of example 39 is employed except that biogas is substituted for the model gas.

### EXAMPLE 39D

The process of example 39 is employed except that landfill gas is substituted for the model gas.

### EXAMPLE 39E

The process of example 39 is employed except that coal mine gas is substituted for the model gas.

### EXAMPLE 39F

The process of example 39 is employed except that reformate gas is substituted for the model gas.

### EXAMPLE 39G

The process of example 39 is employed except that ammonia syngas is substituted for the model gas.

### EXAMPLE 39H

The process of example 39 is employed except that hydrogen gas is substituted for the model gas.

### EXAMPLE 39I

The process of example 39 is employed except that iron ore reduction gas is substituted for the model gas.

### EXAMPLE 39J

The process of example 39 is employed except that indoor air is substituted for the model gas.

### EXAMPLE 39K

The process of example 39 is employed except that fuel cell anode fuel gas is substituted for the model gas.

### EXAMPLE 39L

The process of example 39 is employed except that cathode air gas is substituted for the model gas.

### EXAMPLE 40

The method of example 32 is followed except that 2.58 gm and 1.56 gm of sorbent of example 9 are employed in the first and second stages, respectively.

### EXAMPLE 40A

The process of example 40 is employed except that coal/biomass gasification gas of coal/biomass-fired IGCC power plants is substituted for the model gas.

### EXAMPLE 40B

The process of example 40 is employed except that natural gas is substituted for the model gas.

### EXAMPLE 40C

The process of example 40 is employed except that biogas is substituted for the model gas.

### EXAMPLE 40D

The process of example 40 is employed except that landfill gas is substituted for the model gas.

### EXAMPLE 40E

The process of example 40 is employed except that coal mine gas is substituted for the model gas.

### EXAMPLE 40F

The process of example 40 is employed except that reformate gas is substituted for the model gas.

### EXAMPLE 40G

The process of example 40 is employed except that ammonia syngas is substituted for the model gas.

### EXAMPLE 40H

The process of example 40 is employed except that hydrogen gas is substituted for the model gas.

### EXAMPLE 40I

The process of example 40 is employed except that iron ore reduction gas is substituted for the model gas.

### EXAMPLE 40J

The process of example 40 is employed except that indoor air is substituted for the model gas.

### EXAMPLE 40K

The process of example 40 is employed except that fuel cell anode fuel gas is substituted for the model gas.

### EXAMPLE 40L

The process of example 40 is employed except that cathode air gas is substituted for the model gas.

### EXAMPLE 41

The method of example 32 is followed except that 2.58 gm and 1.56 gm of sorbent of example 10 are employed in the first and second stages, respectively.

### EXAMPLE 41A

The process of example 41 is employed except that coal/biomass gasification gas of coal/biomass-fired IGCC power plants is substituted for the model gas.

### EXAMPLE 41B

The process of example 41 is employed except that natural gas is substituted for the model gas.

### EXAMPLE 41C

The process of example 41 is employed except that biogas is substituted for the model gas.

### EXAMPLE 41D

The process of example 41 is employed except that landfill gas is substituted for the model gas.

### EXAMPLE 41E

The process of example 41 is employed except that coal mine gas is substituted for the model gas.

### EXAMPLE 41F

The process of example 41 is employed except that reformate gas is substituted for the model gas.

### EXAMPLE 41G

The process of example 41 is employed except that ammonia syngas is substituted for the model gas.

### EXAMPLE 41H

The process of example 41 is employed except that hydrogen gas is substituted for the model gas.

### EXAMPLE 41I

The process of example 41 is employed except that iron ore reduction gas is substituted for the model gas.

### EXAMPLE 41J

The process of example 41 is employed except that indoor air is substituted for the model gas.

### EXAMPLE 41K

The process of example 41 is employed except that fuel cell anode fuel gas is substituted for the model gas.

### EXAMPLE 41L

The process of example 41 is employed except that cathode air gas is substituted for the model gas.

### EXAMPLE 42

The method of example 32 is followed except that 2.58 gm and 1.56 gm of sorbent of example 11 are employed in the first and second stages, respectively.

### EXAMPLE 42A

The process of example 42 is employed except that coal/biomass gasification gas of coal/biomass-fired IGCC power plants is substituted for the model gas.

### EXAMPLE 42B

The process of example 42 is employed except that natural gas is substituted for the model gas.

### EXAMPLE 42C

The process of example 42 is employed except that biogas is substituted for the model gas.

### EXAMPLE 42D

The process of example 42 is employed except that landfill gas is substituted for the model gas.

### EXAMPLE 42E

The process of example 42 is employed except that coal mine gas is substituted for the model gas.

### EXAMPLE 42F

The process of example 42 is employed except that reformate gas is substituted for the model gas.

### EXAMPLE 42G

The process of example 42 is employed except that ammonia syngas is substituted for the model gas.

### EXAMPLE 42H

The process of example 42 is employed except that hydrogen gas is substituted for the model gas.

### EXAMPLE 42I

The process of example 42 is employed except that iron ore reduction gas is substituted for the model gas.

### EXAMPLE 42J

The process of example 42 is employed except that indoor air is substituted for the model gas.

### EXAMPLE 42K

The process of example 42 is employed except that fuel cell anode fuel gas is substituted for the model gas.

### EXAMPLE 42L

The process of example 42 is employed except that cathode air gas is substituted for the model gas.

### EXAMPLE 43

The method of example 32 is employed except 2.58 gm sorbent employed in stage 1 is that of example 1 and the sorbent employed in stage 2 is that of example 2.

### EXAMPLE 43A

The process of example 43 is employed except that coal/biomass gasification gas of coal/biomass-fired IGCC power plants is substituted for the model gas.

### EXAMPLE 43B

The process of example 43 is employed except that natural gas is substituted for the model gas.

### EXAMPLE 43C

The process of example 43 is employed except that biogas is substituted for the model gas.

### EXAMPLE 43D

The process of example 43 is employed except that landfill gas is substituted for the model gas.

### EXAMPLE 43E

The process of example 43 is employed except that coal mine gas is substituted for the model gas.

### EXAMPLE 43F

The process of example 43 is employed except that reformate gas is substituted for the model gas.

### EXAMPLE 43G

The process of example 43 is employed except that ammonia syngas is substituted for the model gas.

### EXAMPLE 43H

The process of example 43 is employed except that hydrogen gas is substituted for the model gas.

### EXAMPLE 43I

The process of example 43 is employed except that iron ore reduction gas is substituted for the model gas.

### EXAMPLE 43J

The process of example 43 is employed except that indoor air is substituted for the model gas.

### EXAMPLE 43K

The process of example 43 is employed except that fuel cell anode fuel gas is substituted for the model gas.

### EXAMPLE 43L

The process of example 43 is employed except that cathode air gas is substituted for the model gas.

### EXAMPLE 44

The method of example 32 is employed except 2.58 gm sorbent employed in stage 1 is that of example 2 and the sorbent employed in stage 2 is that of example 3.

### EXAMPLE 44A

The process of example 44 is employed except that coal/biomass gasification gas of coal/biomass-fired IGCC power plants is substituted for the model gas.

### EXAMPLE 44B

The process of example 44 is employed except that natural gas is substituted for the model gas.

### EXAMPLE 44C

The process of example 44 is employed except that biogas is substituted for the model gas.

### EXAMPLE 44D

The process of example 44 is employed except that landfill gas is substituted for the model gas.

### EXAMPLE 44E

The process of example 44 is employed except that coal mine gas is substituted for the model gas.

### EXAMPLE 44F

The process of example 44 is employed except that reformate gas is substituted for the model gas.

### EXAMPLE 44G

The process of example 44 is employed except that ammonia syngas is substituted for the model gas.

### EXAMPLE 44H

The process of example 44 is employed except that hydrogen gas is substituted for the model gas.

### EXAMPLE 44I

The process of example 44 is employed except that iron ore reduction gas is substituted for the model gas.

### EXAMPLE 44J

The process of example 44 is employed except that indoor air is substituted for the model gas.

### EXAMPLE 44K

The process of example 44 is employed except that fuel cell anode fuel gas is substituted for the model gas.

### EXAMPLE 44L

The process of example 44 is employed except that cathode air gas is substituted for the model gas.

### COMPARISON EXAMPLE C1

### Removal of CO₂ and H₂S from a Fuel Gas in a One-Stage Process Compared to a Two-Stage Process

For one stage separation, the procedure of example 12 is followed except that a model fuel gas that contains 0.40 v % of H₂S, 8.00 v % of CO₂, 20 v % of H₂ in N₂ which simulates a coal/biomass gasification gas of coal/biomass-fired IGCC power plants is used. The model fuel gas is prepared by blending 0.40 vol % H₂S gas, 8.0 vol % pure CO₂ gas, 20 vol % UHP hydrogen gas and 71.6 vol % of UHP nitrogen gas (purchased from GT&S Inc.). The breakthrough capacity and saturation capacity achieved by one stage separation for H₂S are 0.016 mmol/g and 0.041 mmol/g, respectively. The breakthrough capacity and saturation capacity achieved by one stage separation for CO₂ are 0.00 mmol/g and 0.09 mmol/g, respectively.

As a comparison, the apparatus of FIG. 2 is used to perform two stage separation as shown in example 32. In contrast to the one stage process, the two-stage process can remove both H₂S and CO₂ from the gas stream.

### EXAMPLE 45

### Removal of NO₂ from a Model Gas that has 2000 ppmv NO2 Over PEG(50)/SBA-15 of Example 10 at 25° C.

The sorption separation of NO₂ from a model gas that has 2000 ppmv NO₂ in N₂ is carried out at atmospheric pressure and 25° C. in a fixed-bed system formed of a straight stainless steel tube that has an inner diameter of 7.5 mm and length of 150 mm. 1.5950 g of the PEG(50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 2000 ppmv of NO₂ in N₂ (purchased from GT&S Inc.) which simulates a field indoor air or a fuel cell cathode air then is passed through the sorption bed at a GHSV of ca. 420 h⁻¹. The breakthrough capacity (“Cap (BT)”) of the sorbent is calculated according to equation 1

$$Cap ( BT ) = \frac{BT \times FR \times {C}_{{NO}_{2}}^{in} \times {10}^{- 6}}{{V}_{mol} \times W} , \qquad ( 1 )$$

where:

Cap (BT) is mmol-NO₂/g sorbent at STP,

BT is the breakthrough time (min) when the NO₂ concentration in the effluent measured at the outlet of the bed reaches 10 ppmv,

FR is the flow rate (mL/min) of the fuel gas,

Vₘₒₗ is the molar volume of the fuel gas (24.4 mL/mmol at standard conditions), W is the weight of the sorbent (in grams) and Cⁱⁿ_{NO}_{₂} is the NO₂ concentration in the untreated fuel gas.

The concentration of NO₂ in the effluent is measured by an on-line ANEK 9000NS Sulfur Analyzer until the sorbent is saturated, as determined by the time when the concentration of NO₂ in the effluent gas reaches a concentration that is the same as that in the model fuel feed gas. The resulting data is plotted to generate a breakthrough curve. The saturation capacity of the sorbent (denoted as Cap (S), mmol-NO2/g, STP) is calculated by integration of the area between the line for the initial concentration of NO₂ in the fuel gas and the breakthrough curve until saturation. The breakthrough capacity and saturation capacity of NO₂ are 0.65 mmol/g and 0.77 mmol/g, respectively.

### EXAMPLE 45A

The process of example 45 is employed except that indoor field air is substituted for the model gas.

### EXAMPLE 45B

The process of example 45 is employed except that flue gas is substituted for the model gas.

### EXAMPLE 45C

The process of example 45 is employed except that oxo-syngas is substituted for the model gas.

### EXAMPLE 46

### Removal of SO₂ from a Model Gas that has 512 ppmv SO₂ Over the PEG(50)/SBA-15 of Example 10 at 25° C.

The sorption separation of SO₂ from a model gas that has 512 ppmv SO₂ is carried out at atmospheric pressure and 25° C. in a fixed-bed system formed of a straight stainless steel tube that has an inner diameter of 7.5 mm and length of 150 mm. 1.5950 g of the PEG(50)/SBA-15 is placed into the column to form a full bed. Before the model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 512 ppmv of SO₂ in N₂ (purchased from GT&S Inc.), which simulates each of field indoor air and fuel cell cathode air then is passed through the sorption bed at a GHSV of ca. 420 h⁻¹. The breakthrough capacity (“Cap (BT)”) of the sorbent is calculated according to equation 1

$$Cap ( BT ) = \frac{BT \times FR \times {C}_{{SO}_{2}}^{in} \times {10}^{- 6}}{{V}_{mol} \times W} , \qquad ( 1 )$$

where:

Cap (BT) is mmol-SO₂/g sorbent at STP,

BT is the breakthrough time (min) when the SO₂ concentration in the effluent measured at the outlet of the bed reaches 2 ppmv,

FR is the flow rate (mL/min) of the fuel gas,

Vₘₒₗ is the molar volume of the fuel gas (24.4 mL/mmol at standard conditions), W is the weight of the sorbent (in grams) and Cⁱⁿ_{SO}_{₂} is the SO₂ concentration in the untreated fuel gas.

The concentration of SO₂ in the effluent is measured by an on-line ANEK 9000NS Sulfur Analyzer until the sorbent is saturated, as determined by the time when the concentration of SO₂ in the effluent gas reaches a concentration that is the same as that in the feed gas. The resulting data is plotted to generate a breakthrough curve. The saturation capacity of the sorbent (denoted as Cap (S), mmol-SO₂/g, STP) is calculated by integration of the area between the line for the initial concentration of SO₂ in the fuel gas and the breakthrough curve until saturation. The breakthrough capacity and saturation capacity of SO₂ are 8.3 mmol/g and 12.3 mmol/g, respectively.

Examples 47-64: illustrate use of adsorbents to remove NO, N₂O, SO₃, HCl, HF, HCN, NH₃, H₂O, C₂H₅OH, CH₃OH, HCHO, CHCl₃, CH₂Cl₂, CH₃C₁, CS₂, C₄H₄S, CH₃SH and CH₃—S—CH₃ from gas streams.

### EXAMPLE 47

### Removal of NO from a Model Gas that has 100 ppmv NO Over PEG(50)/SBA-15 of Example 10 at 25° C.

The sorption separation of NO from a model gas that has 100 ppmv NO in Nitrogen is carried out at atmospheric pressure and 25° C. in a fixed-bed system formed of a straight stainless steel tube that has an inner diameter of 7.5 mm and length of 150 mm. 1.60 g of PEG(50)/SBA-15 as in example 46 is placed into the column to form a full bed. Before the model gas is passed through the sorbent bed, the bed is heated to 100° C. in nitrogen at a GHSV of 700 h⁻¹ (flow rate, 100 mL/min) and held overnight and cooled to room temperature (25° C.). The model gas that contains 100 ppmv of NO in Nitrogen which simulates a field indoor air then is passed through the sorption bed at a GHSV of 420 h^{-1.}

The concentration of NO in the effluent is measured by an on-line Model NGA 2000 Non-Dispersive Infrared NO Analyzer (Rosemount Analytical Inc.) until the sorbent is saturated, as determined by the time when that the concentration of NO in the effluent gas reaches a concentration as the same as that in the feed gas.

### EXAMPLE 48

### Removal of N₂O from a Model Gas that has 100 ppmv N₂O Over PEG(50)/SBA-15 of Example 10 at 22° C.

The sorption separation of N₂O from a model gas that has 100 ppmv N₂O is carried out at atmospheric pressure and 25° C. in a fixed-bed system formed of a straight glass tube that has an inner diameter of 7.5 mm and length of 150 mm. 1.60 g of PEG(50)/SBA-15 produced as in example 46 is placed into the column to form a full bed Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of N₂O in Argon which simulates a field indoor air then is passed through the sorption bed at a GHSV of 420 h⁻¹.

The concentration of N₂O in the effluent is measured by an on-line Model NGA 2000 Non-Dispersive Infrared N₂O Analyzer (Rosemount Analytical Inc.) until the sorbent is saturated, as determined by the time when that the concentration of N₂O in the effluent gas reaches a concentration as the same as that in the feed gas.

### EXAMPLE 49

### Removal of SO₃ from a Model Gas that has 100 ppmv SO₃ Over PEG(50)/SBA-15 of Example 10 at 25° C.

The sorption separation of SO₃ from a model gas that has 100 ppmv SO₃ is carried out at atmospheric pressure and 25° C. in a fixed-bed system formed of a straight stainless steel tube that has an inner diameter of 7.5 mm and length of 150 mm. 1.60 g of PEG(50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of SO₃ which simulates a field indoor air then is passed through the sorption bed at a GHSV of 420 h⁻¹.

The concentration of SO₃ in the effluent is measured by an on-line Model-NGA 2000 SO₃ Analyzer (Rosemount Analytical Inc.) until the sorbent is saturated, as determined by the time when that the concentration of SO₃ in the effluent gas reaches a concentration as the same as that in the feed gas.

### EXAMPLE 49A

The method of example 49 is employed except that field indoor air is substituted for the model gas.

### EXAMPLE 49B

The method of example 49 is employed except that oxo-syngas is substituted for the model gas.

### EXAMPLE 49C

The method of example 49 is employed except that flue gas is substituted for the model gas.

### EXAMPLE 50

### Removal of HCl from a Model Gas that has 100 ppmv HCl Over PEG(50)/SBA-15 of Example 10 at 25° C.

The sorption separation of HCl from a model gas that has 100 ppmv HCl is carried out at atmospheric pressure and 25° C. in a fixed-bed system formed of a straight stainless steel tube that has an inner diameter of 7.5 mm and length of 150 mm. 1.60 g of PEG(50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of HCl in Argon which simulates field indoor air then is passed through the sorption bed at a GHSV of 420 h⁻¹.

The concentration of HCl in the effluent is measured by an on-line Model NGA 2000 HCl Analyzer (Rosemount Analytical Inc.) until the sorbent is saturated, as determined by the time when that the concentration of HCl in the effluent gas reaches a concentration as the same as that in the feed gas.

### EXAMPLE 50A

The method of example 50 is employed except that cathode air is substituted for the model gas.

### EXAMPLE 50B

The method of example 50 is employed except that field indoor air is substituted for the model gas.

### EXAMPLE 51

### Removal of HF from a Model Gas that has 100 ppmv HF Over PEG (50)/SBA-15 of Example 10 at 25° C.

The sorption separation of HF from a model gas that has 100 ppmv HF is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of HF in Argon which simulates field indoor air then is passed through the sorption bed at a GHSV of 420 h⁻¹.

The concentration of HF in the effluent is measured by an on-line Model NGA 2000 HF Analyzer (Rosemount Analytical Inc.) until the sorbent is saturated, as determined by the time when that the concentration of HF in the effluent gas reaches a concentration as the same as that in the feed gas.

### EXAMPLE 51A

The method of example 51 is employed except that cathode air is substituted for the model gas.

### EXAMPLE 52

### Removal of HCN from a Model Gas that has 100 ppmv HCN Over PEG (50)/SBA-15 of Example 10 at 25° C.

The sorption separation of HCN from a model gas that has 100 ppmv HCN is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of HCN in Argon which simulates a field indoor air then is passed through the sorption bed at a GHSV of 420 h⁻¹.

The concentration of HCN in the effluent is measured by an on-line Model NGA 2000 HCN Analyzer (Rosemount Analytical Inc.) until the sorbent is saturated, as determined by the time when that the concentration of HCN in the effluent gas reaches a concentration as the same as that in the feed gas.

### EXAMPLE 53

### Removal of NH₃ from a Model Gas that has 100 ppmv NH₃ Over PEG (50)/SBA-15 of Example 10 at 25° C.

The sorption separation of NH₃ from a model gas that has 100 ppmv NH₃ is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of NH₃ in Argon which simulates a field indoor air then is passed through the sorption bed at a GHSV of 420 h⁻¹.

The concentration of NH₃ in the effluent is measured by an on-line Model NGA 2000 NH₃ Analyzer (Rosemount Analytical Inc.) until the sorbent is saturated, as determined by the time when that the concentration of NH₃ in the effluent gas reaches a concentration as the same as that in the feed gas.

### EXAMPLE 53A

The method of example 53 is employed except that coal/biomass gasification gas is substituted for the model gas.

### EXAMPLE 53B

The method of example 53 is employed except that field indoor air is substituted for the model gas.

### EXAMPLE 53C

The method of example 53 is employed except that biogas is substituted for the model gas.

### EXAMPLE 53D

The method of example 53 is employed except that landfill gas is substituted for the model gas.

### EXAMPLE 53E

The method of example 53 is employed except that coal mine gas is substituted for the model gas.

### EXAMPLE 53F

The method of example 53 is employed except that refinery process gas is substituted for the model gas.

### EXAMPLE 53G

The method of example 53 is employed except that cathode air is substituted for the model gas.

### EXAMPLE 54

### Removal of H₂O from a Model Gas that has 3% H₂O Over PEG (50)/SBA-15 of Example 10 at 25° C.

The sorption separation of H₂O from a model gas that has 3% H₂O is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of H₂O in Argon which simulates a field indoor air then is passed through the sorption bed at a GHSV of 420 h⁻¹.

The concentration of H₂O in the effluent is measured by an on-line GC-TCD (SRI 8610C) until the sorbent is saturated, as determined by the time when that the concentration of H₂O in the effluent gas reaches a concentration as the same as that in the feed gas.

### EXAMPLE 55

### Removal of C₂H₅Oh from a Model Gas that has 100 ppmv C₂H₅Oh over PEG (50)/SBA-15 of Example 10 at 25° C.

The sorption separation of C₂H₂OH from a model gas that has 100 ppmv C₂H₅OH is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of C₂H₅OH in Argon which simulates a field indoor air then is passed through the sorption bed at a GHSV of 420 h^{-1.}

The concentration of C₂H₅OH in the effluent is measured by an on-line Model NGA 2000 C₂H₅OH Analyzer (Rosemount Analytical Inc.) until the sorbent is saturated, as determined by the time when that the concentration of C₂H₅OH in the effluent gas reaches a concentration as the same as that in the feed gas.

### EXAMPLE 55A

The method of example 55 is employed except that field indoor air is substituted for the model gas.

### EXAMPLE 55B

The method of example 53 is employed except that cathode air is substituted for the model gas.

### EXAMPLE 56

### Removal of CH₃OH from a Model Gas that has 100 ppmv CH₃OH over PEG (50)/SBA-15 of Example 10 at 25° C.

The sorption separation of CH₃OH from a model gas that has 100 ppmv CH₃OH is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of CH₃OH in Argon which simulates a field indoor air then is passed through the sorption bed at a GHSV of 420 h⁻¹.

The concentration of CH₃OH in the effluent is measured by an on-line Model NGA 2000 CH₃OH Analyzer (Rosemount Analytical Inc.) until the sorbent is saturated, as determined by the time when that the concentration of CH₃OH in the effluent gas reaches a concentration as the same as that in the feed gas.

### EXAMPLE 56A

The method of example 56 is employed except that field indoor air is substituted for the model gas.

### EXAMPLE 56B

The method of example 56 is employed except that cathode air is substituted for the model gas.

### EXAMPLE 57

### Removal of HCHO from a Model Gas that has 100 ppmv HCHO over PEG (50)/SBA-15 of Example 10 at 25° C.

The sorption separation of HCHO from a model gas that has 100 ppmv HCHO is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of HCHO in Argon which simulates a field indoor air then is passed through the sorption bed at a GHSV of 420 h⁻¹.

The concentration of HCHO in the effluent is measured by an on-line Model NGA 2000 HCHO Analyzer (Rosemount Analytical Inc.) until the sorbent is saturated, as determined by the time when that the concentration of HCHO in the effluent gas reaches a concentration as the same as that in the feed gas.

### EXAMPLE 57A

The method of example 57 is employed except that field indoor air is substituted for the model gas.

### EXAMPLE 57B

The method of example 57 is employed except that cathode air is substituted for the model gas.

### EXAMPLE 58

### Removal of CHCl₃ from a Model Gas that has 100 ppmv CHCl₃ Over PEG (50)/SBA-15 of Example 10 at 25° C.

The sorption separation of CHCl₃ from a model gas that has 100 ppmv CHCl₃ is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of CHCl₃ in Argon which simulates a field indoor air then is passed through the sorption bed at a GHSV of 420 h⁻¹.

The concentration of CHCl₃ in the effluent is measured by an on-line Model NGA 2000 CHCl3 Analyzer (Rosemount Analytical Inc.) until the sorbent is saturated, as determined by the time when that the concentration of CHCl₃ in the effluent gas reaches a concentration as the same as that in the feed gas.

### EXAMPLE 58A

The method of example 58 is employed except that field indoor air is substituted for the model gas.

### EXAMPLE 58B

The method of example 58 is employed except that cathode air is substituted for the model gas.

### EXAMPLE 59

### Removal of CH₂Cl₂ from a Model Gas that has 100 ppmv CH₂Cl₂ over PEG (50)/SBA-15 of Example 10 at 25° C.

The sorption separation of CH₂Cl₂ from a model gas that has 100 ppmv CH₂Cl₂ is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of CH₂Cl₂ in Argon which simulates a field indoor air then is passed through the sorption bed at a GHSV of 420 h⁻¹.

The concentration of CH₂Cl₂ in the effluent is measured by an on-line Model NGA 2000 CH₂Cl₂ Analyzer (Rosemount Analytical Inc.) until the sorbent is saturated, as determined by the time when that the concentration of CH₂Cl₂ in the effluent gas reaches a concentration as the same as that in the feed gas.

### EXAMPLE 59A

The method of example 59 is employed except that field indoor air is substituted for the model gas.

### EXAMPLE 59B

The method of example 59 is employed except that cathode air is substituted for the model gas.

### EXAMPLE 60

### Removal of CH₃Cl from a Model Gas that has 100 ppmv CH₃Cl Over PEG (50)/SBA-15 of Example 10 at 25° C.

The sorption separation of CH₃Cl from a model gas that has 100 ppmv CH₃Cl is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of CH₃Cl in Argon which simulates a field indoor air then is passed through the sorption bed at a GHSV of 420 h⁻¹.

The concentration of CH₃Cl in the effluent is measured by an on-line Model NGA 2000 CH₃Cl Analyzer (Rosemount Analytical Inc.) until the sorbent is saturated, as determined by the time when that the concentration of CH₃Cl in the effluent gas reaches a concentration as the same as that in the feed gas.

### EXAMPLE 60A

The method of example 60 is employed except that field indoor air is substituted for the model gas.

### EXAMPLE 61

### Removal of CS₂ from a Model Gas that has 100 ppmv Cs₂ Over PEG (50)/SBA-15 of Example 10 at 25° C.

The sorption separation of CS₂ from a model gas that has 100 ppmv CS₂ is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of CS₂ in Argon which simulates a field indoor air then is passed through the sorption bed at a GHSV of 420 h⁻¹.

The concentration of CS₂ in the effluent is measured by an on-line Model NGA 2000 CS2 Analyzer (Rosemount Analytical Inc.) until the sorbent is saturated, as determined by the time when that the concentration of CS₂ in the effluent gas reaches a concentration as the same as that in the feed gas.

### EXAMPLE 61A

The method of example 61 is employed except that field indoor air is substituted for the model gas.

### EXAMPLE 61B

The method of example 61 is employed except that cathode air is substituted for the model gas.

### EXAMPLE 62

### Removal of C₄H₄S from a Model Gas that has 100 ppmv C₄H₄S Over PEG (50)/SBA-15 of Example 10 at 25° C.

The sorption separation of C₄H₄S from a model gas that has 100 ppmv C₄H₄S is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of C₄H₄S in Argon which simulates a field indoor air then is passed through the sorption bed at a GHSV of 420 h⁻¹.

The concentration of C₄H₄S in the effluent is measured by an on-line Model NGA 2000 C₄H₄S Analyzer (Rosemount Analytical Inc.) until the sorbent is saturated, as determined by the time when that the concentration of C₄H₄S in the effluent gas reaches a concentration as the same as that in the feed gas.

### EXAMPLE 62A

The method of example 62 is employed except that field indoor air is substituted for the model gas.

### EXAMPLE 62B

The method of example 62 is employed except that cathode air is substituted for the model gas.

### EXAMPLE 63

### Removal of CH₃SH from a Model Gas that has 100 ppmv CH₃SH over PEG (50)/SBA-15 of Example 10 at 25° C.

The sorption separation of CH₃SH from a model gas that has 100 ppmv CH₃SH is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of CH₃SH in Argon which simulates a field indoor air then is passed through the sorption bed at a CH₃SH of 420 h⁻¹.

The concentration of CH₃SH in the effluent is measured by an on-line Model NGA 2000 CH₃SH Analyzer (Rosemount Analytical Inc.) until the sorbent is saturated, as determined by the time when that the concentration of CH₃SH in the effluent gas reaches a concentration as the same as that in the feed gas.

### EXAMPLE 63A

The method of example 63 is employed except that field indoor air is substituted for the model gas.

### EXAMPLE 63B

The method of example 63 is employed except that natural gas is substituted for the model gas.

### EXAMPLE 63C

The method of example 63 is employed except that refinery process gas is substituted for the model gas.

### EXAMPLE 64

### Removal of CH₃—S—CH₃ from a Model Gas that has 100 ppmv CH₃—S—CH₃ over PEG (50)/SBA-15 of Example 10 at 25° C.

The sorption separation of CH₃—S—CH₃ from a model gas that has 100 ppmv CH₃—S—CH₃ is carried out at atmospheric pressure and 25° C. in a fixed-bed system formed of a straight stainless steel tube that has an inner diameter of 7.5 mm and length of 150 mm. 1.60 g of PEG (50)/SBA-15 is placed into the column to form a full bed. Before a model gas is passed through the sorbent bed, the bed is heated to 100° C. in nitrogen at a GHSV of 700 h⁻¹ (flow rate, 100 mL/min) and held overnight and cooled to room temperature (25° C.).

A model gas that contains 100 ppmv of CH₃—S—CH₃ in Argon which simulates a field indoor air then is passed through the sorption bed at a GHSV of 420 h⁻¹.

The concentration of CH₃—S—CH₃ in the effluent is measured by an on-line Model NGA 2000 CH₃—S—CH₃ Analyzer (Rosemount Analytical Inc.) until the sorbent is saturated, as determined by the time when that the concentration of CH₃—S—CH₃ in the effluent gas reaches a concentration as the same as that in the feed gas.

### EXAMPLE 64A

The method of example 64 is employed except that field indoor air is substituted for the model gas.

### EXAMPLE 64B

The method of example 64 is employed except that refinery process gas is substituted for the model gas.

### EXAMPLE 64C

The method of example 64 is employed except that natural gas is substituted for the model gas.

### EXAMPLE 65

### Two-Stage Process for Removal of CO₂ and H₂S, Respectively, from Model Gas Stream that Simulates a Biogas Stream

The apparatus for two-stage sorption process for removing CO₂ and H₂S is shown in FIG. 2. The sorption column in the first stage is a stainless steel column and is packed with 5.12 gm of the PEI(50)/Cab-O-Sil sorbent of example 9. The sorption column employed in the second stage is packed with 1.24 g of the PEI(50)/Cab-O-Sil sorbent of example 9.

A model gas stream that simulates biogas is passed through the sorption column employed in stage 1 of the apparatus shown in FIG. 2 at a flow rate of 100 ml/min 1263 h⁻¹ GHSV) to remove CO₂ from the simulated biogas stream. The temperature of the sorption column employed in the first stage for removal of CO₂ is 75° C. The effluent generated by stage 1 then is passing through the sorption column employed in stage 2 at the flow rate of 100 mL/min(3797 h⁻¹ GHSV) to remove H₂S from the simulated biogas stream. The temperature of the sorption column employed in the second stage is room temperature (25° C.).

The model gas includes 750 ppmv H₂S, 40 v % CO₂, 56 v % of CH₄ and 3.925 v % of N₂, which simulates a local biogas, prepared by blending 3.925 v % ultra-high pure (UHP) nitrogen, 56 v % of CH₄, 750 ppmv H₂S and 40 v % CO₂ (purchased from GT&S Inc.).

The concentrations of CO₂ and H₂S at the outlet of the process is analyzed by on-line gas chromatography and an on-line ANTEK 9000NS Sulfur Analyzer, respectively, until the sorbents in both stages are saturated, as determined by the time when that the concentrations of CO2 and H2S in the effluent gas reach the concentrations as the same as those in the feed gas.

After two-stage sorption, the CO₂ breakthrough time is 4.5 min, corresponding to a breakthrough capacity of 1.45 mmol-CO₂/g-sorbent. And, the H₂S breakthrough time is 11 min, corresponding to a breakthrough capacity of 6.64 μmol-H₂S/g-sorbent.

### EXAMPLE 65A

The process of example 65 is employed except that biogas is substituted for the model gas.

### EXAMPLE 65B

The process of example 65 is employed except that natural gas is substituted for the model gas.

### EXAMPLE 65C

The process of example 65 is employed except that biogas is substituted for the model gas.

### EXAMPLE 65D

The process of example 65 is employed except that landfill gas is substituted for the model gas.

### EXAMPLE 65E

The process of example 65 is employed except that coal mine gas is substituted for the model gas.

### EXAMPLE 65F

The process of example 65 is employed except that reformate gas is substituted for the model gas.

### EXAMPLE 65G

The process of example 65 is employed except that ammonia syngas is substituted for the model gas.

### EXAMPLE 65H

The process of example 65 is employed except that hydrogen gas is substituted for the model gas.

### EXAMPLE 65I

The process of example 65 is employed except that iron ore reduction gas is substituted for the model gas.

### EXAMPLE 65J

The process of example 65 is employed except that indoor air is substituted for the model gas.

### EXAMPLE 65K

The process of example 65 is employed except that fuel cell anode fuel gas is substituted for the model gas.

### EXAMPLE 65L

The process of example 65 is employed except that cathode air gas is substituted for the model gas.

### EXAMPLE 66

### Two-Stage Process for Removal of CO₂ and H₂S, Respectively, from a Landfill Gas Stream

The apparatus for two-stage sorption process for removing CO₂ and H₂S is shown in FIG. 2. The sorption column in the first stage is a stainless steel column and is packed with 5.12 gm of the PEI(50)/Cab-O-Sil sorbent of example 9. The sorption column employed in the second stage is packed with 1.24 g of the PEI(50)/Cab-O-Sil sorbent of example 9.

A local landfill gas is passing through the sorption column employed in stage 1 of the apparatus shown in FIG. 2 at a flow rate of 100 ml/min (1263 h⁻¹ GHSV) to remove CO₂ from the landfill gas stream. The temperature of the sorption column employed in the first stage for removal of CO₂ is 75° C. The effluent generated by stage 1 then is passing through the sorption column employed in stage 2 at the flow rate of 100 mL/min (3797 h⁻¹ GHSV) to remove H₂S from the simulated biogas stream. The temperature of the sorption column employed in the second stage is room temperature (25° C.).

The landfill gas mainly contains 166 ppmv H₂S, 30.8 v % CO₂, 62.0 v % of CH₄, 2.1 v % O₂ and 3.9 v % of N₂ supplied by local and analyzed by Research Triangle Park laboratories, Inc.

The concentrations of CO₂ and H₂S at the outlet of the process is analyzed by on-line gas chromatography and an on-line ANTEK 9000NS Sulfur Analyzer, respectively, until the sorbents in both stages are saturated, as determined by the time when that the concentrations of CO₂ and H2S in the effluent gas reach the concentrations as the same as those in the feed gas.

### EXAMPLE 66A

The process of example 66 is employed except that natural gas is substituted for the model gas.

### EXAMPLE 66B

The process of example 66 is employed except that biogas is substituted for the model gas.

### EXAMPLE 66C

The process of example 66 is employed except that landfill gas is substituted for the model gas.

### EXAMPLE 66D

The process of example 66 is employed except that coal mine gas is substituted for the model gas.

### EXAMPLE 66E

The process of example 66 is employed except that reformate gas is substituted for the model gas.

### EXAMPLE 66F

The process of example 66 is employed except that ammonia syngas is substituted for the model gas.

### EXAMPLE 66G

The process of example 66 is employed except that hydrogen gas is substituted for the model gas.

### EXAMPLE 66H

The process of example 66 is employed except that iron ore reduction gas is substituted for the model gas.

### EXAMPLE 66I

The process of example 66 is employed except that indoor air is substituted for the model gas.

### EXAMPLE 66J

The process of example 66 is employed except that fuel cell anode fuel gas is substituted for the model gas.

### EXAMPLE 66K

The process of example 66 is employed except that cathode air gas is substituted for the model gas.

1. A two-stage process for separation of removal a plurality of impurities from a feed gas stream comprising,
contacting a feed gas stream having a plurality of impurities therein with a first sorbent during a first stage to remove a first one of the plurality of impurities from the feed gas stream to generate a first effluent stream having a lower amount of the first impurity than in the feed gas stream,
contacting the first effluent with a second sorbent in a second stage where the second sorbent may be the same or different from the first sorbent to remove a second one of the plurality of impurities from the first effluent to produce a second effluent having a lower amount of the second one of the plurality of impurities than in the first effluent stream,
wherein in the first stage the first sorbent is maintained at about 10° C. to about 130° C. and the gas feed stream is contacted with the first sorbent at a first flow rate GHSV of about 200 h⁻¹ to about 200,000 h⁻¹ and
wherein in the second stage the second sorbent is maintained at about −10° C. to about 80° C. and the first effluent is contacted with the second sorbent at a second flow rate GHSV of about 200 h⁻¹ about 2×10⁵ h^{-l}, and
wherein the first and second impurities are selected from the group consisting of H₂S, COS, CO₂, NO₂, NO, N₂O, SO₂, SO₃, HCl, HF, HCN, NH₃, H₂O, C₂H₅OH, CH₃OH, HCHO, CHCl₃, CH₂Cl₂, CH₃Cl—, CS₂, C₄H₄S, CH₃SH, CH₃—S—CH₃ and mixtures thereof and
wherein the feed gas stream is selected from the group consisting of natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air, and
wherein each of the sorbents in the first and second stages comprises at least one of a polymer, compound or mixtures of polymer and compound on a porous support material where the polymer is selected from the group consisting of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH— and CH₃—S—CH-phillic polymers or mixtures thereof and the compound is selected from the group consisting of H₂S—, COS—CO₂—, NO₂—, NO—, N₂O—, SO₂—, SO₃—, HCl—, HF—, HCN—, NH₃—, H₂O—, C₂H₅OH—, CH₃OH—, HCHO—, CHCl₃—, CH₂Cl₂—, CH₃Cl—, CS₂—, C₄H₄S—, CH₃SH—, CH₃—S—CH-phillic compounds or mixtures thereof,
wherein the polymeric and organic compound are each selected from the group consisting of polyethylenimine, polyethyleneglycolamine, polyethanolamine, polyisopropanolamine, polyalkylene glycol dimethyl ether, polyethylene glycol, n-methylpyrrolidinone, n-formylmorpholine, N-acetylmorpholine, propylene carbonate, sulfolane and mixtures thereof and
wherein the porous support material is selected from the group consisting of alumino-silicates, activated carbon, carbon sieves, silica gel, fumed silica, silica and mixtures thereof.

2. The process of claim 1 wherein the gas feed stream is coal/biomass gasification gas, the polymer is polyethylenimine, the support is an alumino-silicate, stage 1 is at a temperature of 75° C. the first one of the impurities is CO₂, stage 2 is at a temperature of 22° C. and the second one of the impurities is H₂S.

3. The process of claim 2 wherein the GHSV of the feed gas is 486 h⁻¹ and the GHSV of the first effluent is 486 h⁻¹.

4. The process of claim 1 wherein the gas feed stream is biogas, the polymer is polyethylenimine, the support is fumed silica, stage 1 is at a temperature of 75° C. the first one of the impurities is CO₂, stage 2 is at a temperature of 25° C. and the second one of the impurities is H₂S.

5. The process of claim 4 wherein the GHSV of the feed gas is 1263 h⁻¹ and the GHSV of the first effluent is 3797 h⁻¹

6. The process of claim 1 wherein the feed gas stream is landfill gas, the polymer is polyethylenimine, the support is fumed silica, stage 1 is at a temperature of 75° C. the first one of the impurities is CO₂, stage 2 is at a temperature of 25° C. and the second one of the impurities is H₂S.

7. A sorbent for sorbing one or more impurities from a gas stream, the sorbent comprising a first component for sorbing one or more impurities from the gas stream, and a second component comprising a porous support material for supporting the first component, wherein the first component is selected from the group consisting of polyethyleneglycolamine (PEGA), polyethanolamine (PEA), polyisopropanolamine (PIPA), polyalkylene glycol dimethyl ether (PAGDE), polyethylene glycol (PEG), n-methylpyrrolidinone (NMP), n-formylmorpholine (NFM), N-acetylmorpholine (NAM), propylene carbonate, sulfolane, or mixtures thereof, and the porous support material is selected from the group consisting of alumino-silicates, activated carbon, carbon sieve, silica gel, fumed silica, silica or mixtures thereof.

8. A sorbent for sorbing one or more impurities from a gas stream, the sorbent comprising a first component for sorbing one or more impurities from the gas stream, and a second component comprising a porous support material for supporting the first component, wherein the first component is selected from the group consisting of polyethylenimine (PEI), polyethyleneglycolamine (PEGA), polyethanolamine (PEA), polyisopropanolamine (PIPA), polyalkylene glycol dimethyl ether (PAGDE), polyethylene glycol (PEG), n-methyl pyrrolidinone (NMP), n-formylmorpholine (NFM), N-acetylmorpholine (NAM), propylene carbonate, sulfolane, modified polymers listed above or mixtures thereof, and the porous support material is selected from the group consisting of activated carbon, carbon sieve, silica gel, fumed silica, silica or mixtures thereof.

9. The sorbent of claim 7 wherein the first component is polyethylene glycol and the porous support is alumino-silicate.

10. The sorbent of claim 8 wherein the first component is polyethylenimine and the porous support is fumed silica.

11. A sorbent for sorbing one or more impurities from a gas stream, the sorbent comprising a mixture of polyethylenimine polyethylene glycol on an alumino silicate.

12. A single stage process for separation of an impurity from a feed gas stream comprising,
contacting the feed gas stream having an impurity over a bed of a sorbent at a flow rate GHSV of about 200 h⁻¹ to about 200,000 h⁻¹ at a temperature of about −10° C. to about 80° C. to remove the impurity from the gas stream to produce an effluent that has a lower amount of the impurity than the feed gas stream,
wherein the impurity is selected from the group consisting of CO₂, H₂S, COS, NO₂, NO, N₂O, SO₂, SO₃, HCl, HF, HCN, NH₃, H₂O, C₂H₅OH, CH₃OH, HCHO, CHCl₃, CH₂Cl₂, CH₃C₁—, CS₂, C₄H₄S, CH₃SH, CH₃—S—CH₃ and mixtures thereof and
the gas stream is selected from the group consisting of natural gas, coal/biomass gasification gas, biogas, landfill gas, coal mine gas, ammonia syngas, H₂ and oxo-syngas, Fe ore reduction gas, reformate gas, refinery process gases, indoor air, fuel cell anode fuel gas and cathode air, and wherein the sorbent comprises a first component for sorbing one or more impurities from the gas stream, and a second component comprising a porous support material for supporting the first component, wherein the first component is selected from the group consisting of polyethyleneglycolamine (PEGA), polyethanolamine (PEA), polyisopropanolamine (PIPA), polyalkylene glycol dimethyl ether (PAGDE), polyethylene glycol (PEG), n-methyl pyrrolidinone (NMP), n-formylmorpholine (NFM), N-acetylmorpholine (NAM), propylene carbonate, sulfolane, or mixtures thereof, and the porous support material is selected from the group consisting of alumino-silicates, activated carbon, carbon sieve, silica gel, fumed silica, silica or mixtures thereof.

13. The process of claim 12 wherein the feed gas is dry coal/biomass gasification gas that has H₂S impurity, the sorbent comprises polyethylenimine on alumino-silicate support, the temperature is 22° C. and the GHSV of the feed gas over the sorbent is 674 h⁻¹.

14. The process of claim 12 wherein the feed gas is dry flue gas that has CO₂ impurity, the flow rate GHSV of the feed gas over the sorbent is 337 h⁻¹ and the temperature is 75° C.

15. The process of claim 2 wherein the feed gas is natural gas.

16. The process of claim 2 wherein the feed gas is biogas.

17. The process of claim 2 wherein the feed gas is landfill gas.

18. The process of claim 2 wherein the feed gas is coal mine gas.

19. The process of claim 2 wherein the feed gas is reformate gas.

20. The process of claim 2 wherein the feed gas is hydrogen.

21. The process of claim 2 wherein the feed gas is indoor air.
